(19) United States
(12) Patent Application Publication
(10) Pub. No.: US 2026/0333390 A1
(43) Pub. Date: Oct. 22, 2026

(54) SIDELINK UNLICENSED WIDEBAND PHYSICAL SIDELINK FEEDBACK CHANNEL (PSFCH) FOR CAPACITY ENHANCED PSFCH FORMAT 0 OR PSFCH FORMAT 2

(71) Applicant: QUALCOMM Incorporated, San Diego, CA (US)

(72) Inventors: Chih-Hao LIU, San Diego, CA (US); Jing SUN, San Diego, CA (US); Giovanni CHISCI, San Diego, CA (US); Xiaoxia ZHANG, San Diego, CA (US); Stelios STEFANATOS, San Diego, CA (US); Peter GAAL, San Diego, CA (US)

(21) Appl. No.: 19/110,619

(22) PCT Filed: Oct. 30, 2023
(86) PCT No.: PCT/US2023/078218

§ 371 Date: Mar. 11, 2025

(30) Foreign Application Priority Data
Nov. 3, 2022 (GR) 20220100897

(51) Int. Cl. H04W 72/25; H04L 1/00; H04L 5/00

(52) U.S. Cl. CPC H04W 72/25; H04L 1/0061; H04L 5/0098

(57) ABSTRACT

Various aspects of the present disclosure generally relate to wireless communication. In some aspects, a user equipment (UE) may receive a sidelink communication in a first plurality of interlaces of a plurality of resource block (RB)-sets in a shared frequency band. The UE may transmit a wideband sidelink feedback communication associated with the sidelink communication in a second plurality of interlaces of the plurality of RB-sets, the wideband sidelink feedback communication being transmitted in at least a first set of physical sidelink feedback channel (PSFCH) resources having a first format. Numerous other aspects are described.

### CROSS-REFERENCE TO RELATED APPLICATION

This Patent Application claims priority to Greece Patent Application No. 20220100897, filed on Nov. 3, 2022, entitled “SIDELINK UNLICENSED WIDEBAND PHYSICAL SIDELINK FEEDBACK CHANNEL (PSFCH) FOR CAPACITY ENHANCED PSFCH FORMAT 0 OR PSFCH FORMAT 2,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for a sidelink unlicensed (SL-U) wideband physical sidelink feedback channel (PSFCH) for capacity enhanced PSFCH format 0 (PF0) or PSFCH format 2 (PF2).

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving a plurality of resource block (RB)-set specific configurations, each RB-set specific configuration corresponding to a respective RB-set from a plurality of RB-sets in a shared frequency band, where each RB-set specific configuration of the plurality of RB-set specific configurations indicates at least one of a first set of physical sidelink feedback channel (PSFCH) resources having a first format or a second set of PSFCH resources having a second format that is different from the first format.

The method may include receiving a sidelink communication in at least a first interlace of an RB-set included in the plurality of RB-sets. The method may include transmitting a sidelink feedback communication associated with the sidelink communication in at least a second interlace of the RB-set, where the sidelink feedback communication is transmitted based at least in part on an RB-set specific configuration associated with the RB-set.

Some aspects described herein relate to a method of wireless communication performed by a UE. The method may include receiving a sidelink communication in a first plurality of interlaces of a plurality of RB-sets in a shared frequency band. The method may include transmitting a wideband sidelink feedback communication associated with the sidelink communication in a second plurality of interlaces of the plurality of RB-sets, the wideband sidelink feedback communication being transmitted in at least a first set of PSFCH resources having a first format.

Some aspects described herein relate to a method of wireless communication performed by a first UE. The method may include transmitting, to a second UE, a configuration indicating a set of wideband PSFCH parameters or a set of wideband listen-before-talk (LBT) parameters. The method may include transmitting a sidelink communication to the second UE after transmitting the configuration.

Some aspects described herein relate to an apparatus for wireless communication at a UE. The apparatus may include a processor, a memory coupled to the processor, and instructions stored in the memory. The instructions may be executable by the processor to cause the apparatus to receive a plurality of RB-set specific configurations, each RB-set specific configuration corresponding to a respective RB-set from a plurality of RB-sets in a shared frequency band, where each RB-set specific configuration of the plurality of RB-set specific configurations indicates at least one of a first set of PSFCH resources having a first format or a second set of PSFCH resources having a second format that is different from the first format.

The instructions may be executable by the processor to cause the apparatus to receive a sidelink communication in at least a first interlace of an RB-set included in the plurality of RB-sets. The instructions may be executable by the processor to cause the apparatus to transmit a sidelink feedback communication associated with the sidelink communication in at least a second interlace of the RB-set, where the sidelink feedback communication is transmitted based at least in part on an RB-set specific configuration associated with the RB-set.

Some aspects described herein relate to an apparatus for wireless communication at a UE. The apparatus may include a processor, a memory coupled to the processor, and instructions stored in the memory. The instructions may be executable by the processor to cause the apparatus to receive a sidelink communication in a first plurality of interlaces of a plurality of RB-sets in a shared frequency band. The instructions may be executable by the processor to cause the apparatus to transmit a wideband sidelink feedback communication associated with the sidelink communication in a second plurality of interlaces of the plurality of RB-sets, the wideband sidelink feedback communication being transmitted in at least a first set of PSFCH resources having a first format.

Some aspects described herein relate to an apparatus for wireless communication at a UE. The UE may include a processor, a memory coupled to the processor, and instructions stored in the memory. The instructions may be executable by the processor to cause the apparatus to transmit, to a second UE, a configuration indicating a set of wideband PSFCH parameters or a set of wideband LBT parameters. The instructions may be executable by the processor to cause the apparatus to transmit a sidelink communication to the second UE after transmitting the configuration.

Some aspects described herein relate to a non-transitory computer-readable medium that stores a set of instructions for wireless communication by a UE. The set of instructions, when executed by one or more processors of the UE, may cause the UE to receive a plurality of RB-set specific configurations, each RB-set specific configuration corresponding to a respective RB-set from a plurality of RB-sets in a shared frequency band, where each RB-set specific configuration of the plurality of RB-set specific configurations indicates at least one of a first set of PSFCH resources having a first format or a second set of PSFCH resources having a second format that is different from the first format. The set of instructions, when executed by one or more processors of the UE, may cause the UE to receive a sidelink communication in at least a first interlace of an RB-set included in the plurality of RB-sets. The set of instructions, when executed by one or more processors of the UE, may cause the UE to transmit a sidelink feedback communication associated with the sidelink communication in at least a second interlace of the RB-set, where the sidelink feedback communication is transmitted based at least in part on an RB-set specific configuration associated with the RB-set.

Some aspects described herein relate to a non-transitory computer-readable medium that stores a set of instructions for wireless communication by a UE. The set of instructions, when executed by one or more processors of the UE, may cause the UE to receive a sidelink communication in a first plurality of interlaces of a plurality of RB-sets in a shared frequency band. The set of instructions, when executed by one or more processors of the UE, may cause the UE to transmit a wideband sidelink feedback communication associated with the sidelink communication in a second plurality of interlaces of the plurality of RB-sets, the wideband sidelink feedback communication being transmitted in at least a first set of PSFCH resources having a first format.

Some aspects described herein relate to a non-transitory computer-readable medium that stores a set of instructions for wireless communication by a first UE. The set of instructions, when executed by one or more processors of the first UE, may cause the first UE to transmit, to a second UE, a configuration indicating a set of wideband PSFCH parameters or a set of wideband LBT parameters. The set of instructions, when executed by one or more processors of the first UE, may cause the first UE to transmit a sidelink communication to the second UE after transmitting the configuration.

Some aspects described herein relate to an apparatus for wireless communication.

The apparatus may include means for receiving a plurality of RB-set specific configurations, each RB-set specific configuration corresponding to a respective RB-set from a plurality of RB-sets in a shared frequency band, where each RB-set specific configuration of the plurality of RB-set specific configurations indicates at least one of a first set of PSFCH resources having a first format or a second set of PSFCH resources having a second format that is different from the first format. The apparatus may include means for receiving a sidelink communication in at least a first interlace of an RB-set included in the plurality of RB-sets. The apparatus may include means for transmitting a sidelink feedback communication associated with the sidelink communication in at least a second interlace of the RB-set, where the sidelink feedback communication is transmitted based at least in part on an RB-set specific configuration associated with the RB-set.

Some aspects described herein relate to an apparatus for wireless communication. The apparatus may include means for receiving a sidelink communication in a first plurality of interlaces of a plurality of RB-sets in a shared frequency band. The apparatus may include means for transmitting a wideband sidelink feedback communication associated with the sidelink communication in a second plurality of interlaces of the plurality of RB-sets, the wideband sidelink feedback communication being transmitted in at least a first set of PSFCH resources having a first format.

Some aspects described herein relate to an apparatus for wireless communication. The apparatus may include means for transmitting, to a UE, a configuration indicating a set of wideband PSFCH parameters or a set of wideband LBT parameters. The apparatus may include means for transmitting a sidelink communication to the UE after transmitting the configuration.

Aspects generally include a method, apparatus, system, computer program product, non-transitory computer-readable medium, user equipment, base station, network entity, network node, wireless communication device, and/or processing system as substantially described herein with reference to and as illustrated by the drawings, specification, and appendix.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example of sidelink communications, in accordance with the present disclosure.

FIG. 4 is a diagram illustrating an example of sidelink communications and access link communications, in accordance with the present disclosure.

FIG. 5 illustrates a sidelink communication scheme using a frequency-interlaced waveform, in accordance with the present disclosure.

FIGS. 6A and 6B are diagrams illustrating examples associated with mapping physical sidelink shared channel (PSSCH) communications to physical sidelink feedback channel (PSFCH) resources, in accordance with the present disclosure.

FIG. 7 illustrates an example of resources associated with frequency division multiplexed PSFCH transmissions, in accordance with the present disclosure.

FIG. 8 illustrates an example of resources associated with time division multiplexed PSFCH transmissions, in accordance with the present disclosure.

FIGS. 9A and 9B are diagrams illustrating examples associated with a sidelink unlicensed (SL-U) wideband PSFCH for capacity enhanced PSFCH format 0 (PF0) or PSFCH format 2 (PF2), in accordance with the present disclosure.

FIG. 10 is a diagram illustrating an example associated with an SL-U wideband PSFCH for capacity enhanced PF0 or PF2, in accordance with the present disclosure.

FIG. 11 is a diagram illustrating an example associated with an SL-U wideband PSFCH for capacity enhanced PF0 or PF2, in accordance with the present disclosure.

FIGS. 12-14 are diagrams illustrating example processes performed, for example, by a UE, in accordance with the present disclosure.

FIG. 15 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

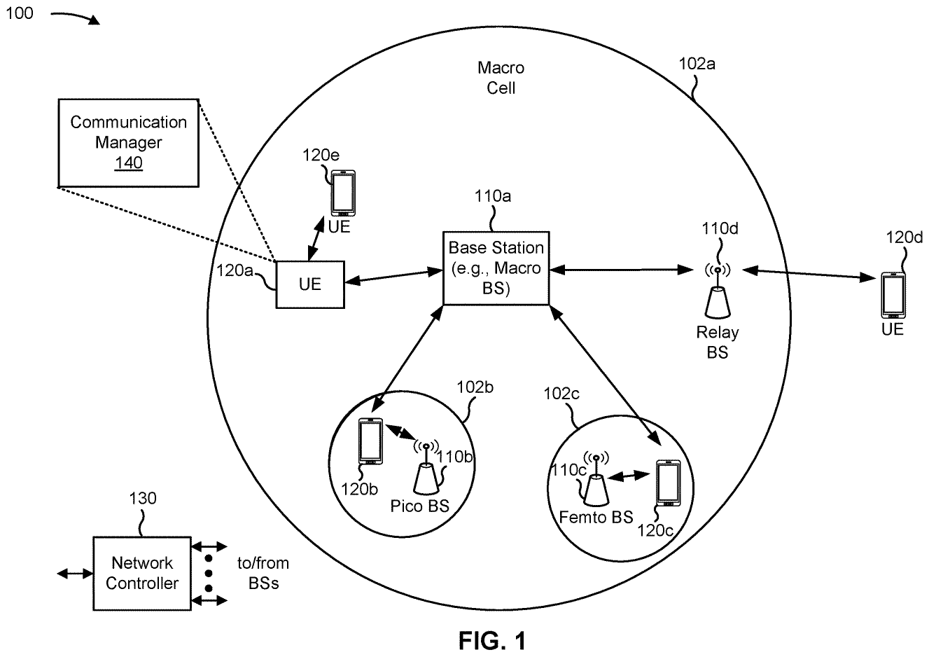

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUS)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHz). It should be understood that although a portion of FRI is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHZ), FR4 (52.6 GHz-114.25 GHZ), and FR5 (114.25 GHz-300 GHZ).

Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive a plurality of RB-set specific configurations, each RB-set specific configuration corresponding to a respective RB-set from a plurality of RB-sets in a shared frequency band, wherein each RB-set specific configuration of the plurality of RB-set specific configurations indicates at least one of a first set of PSFCH resources having a first format or a second set of PSFCH resources having a second format that is different from the first format; receive a sidelink communication in at least a first interlace of an RB-set included in the plurality of RB-sets; and transmit a sidelink feedback communication associated with the sidelink communication in at least a second interlace of the RB-set, wherein the sidelink feedback communication is transmitted based at least in part on an RB-set specific configuration associated with the RB-set. In some aspects, the communication manager 140 may receive a sidelink communication in a first plurality of interlaces of a plurality of RB-sets in a shared frequency band; and transmit a wideband sidelink feedback communication associated with the sidelink communication in a second plurality of interlaces of the plurality of RB-sets, the wideband sidelink feedback communication being transmitted in at least a first set of PSFCH resources having a first format. In some aspects, the communication manager 140 may transmit, to a second UE, a configuration indicating a set of wideband PSFCH parameters or a set of wideband LBT parameters; and transmit a sidelink communication to the second UE after transmitting the configuration. Additionally, or alternatively, the communication manager 140 may perform one or more other operations described herein.

As indicated above, FIG. 1 is provided as an example. Other examples may differ from what is described with regard to FIG. 1.

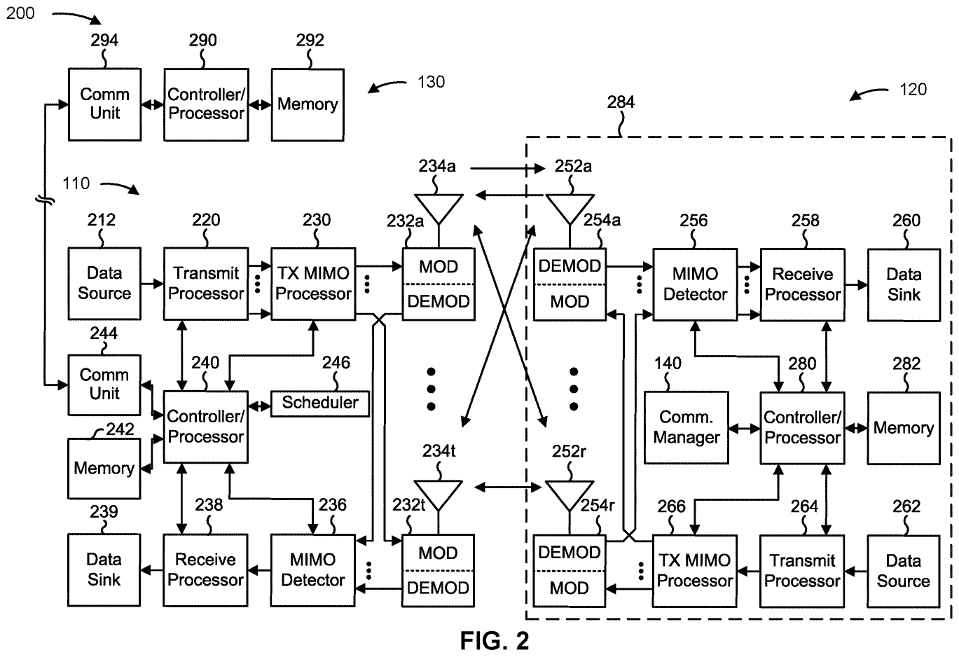

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

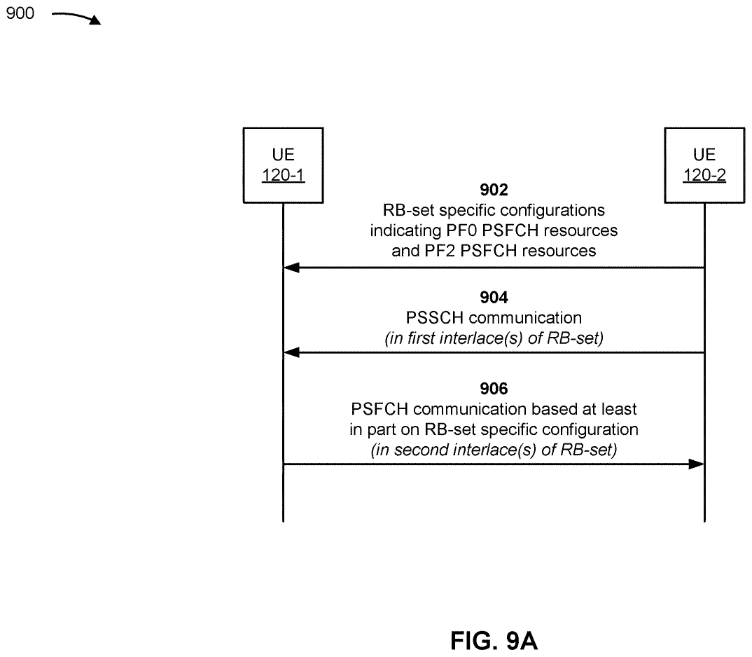

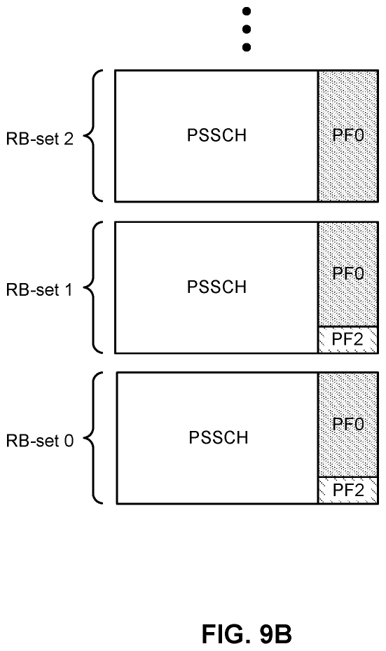

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 9A-15).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 9A-15).

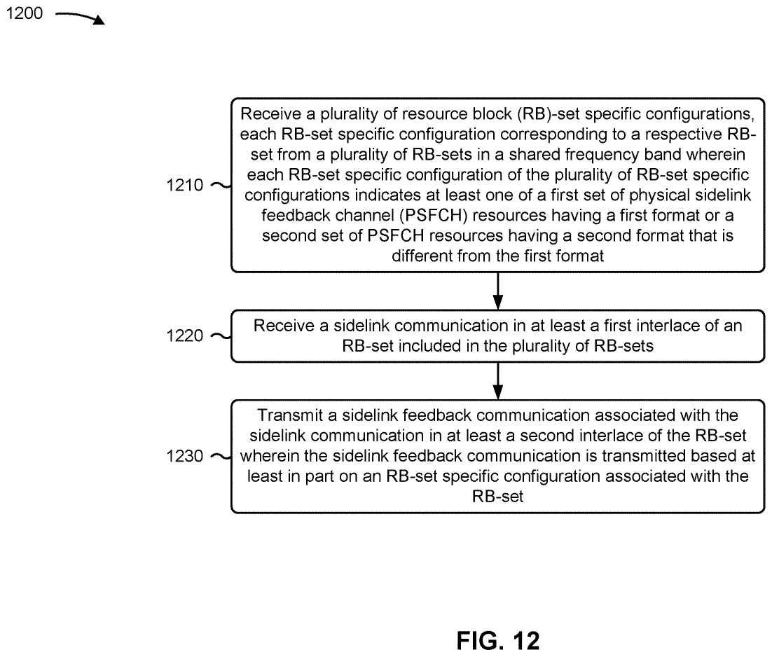

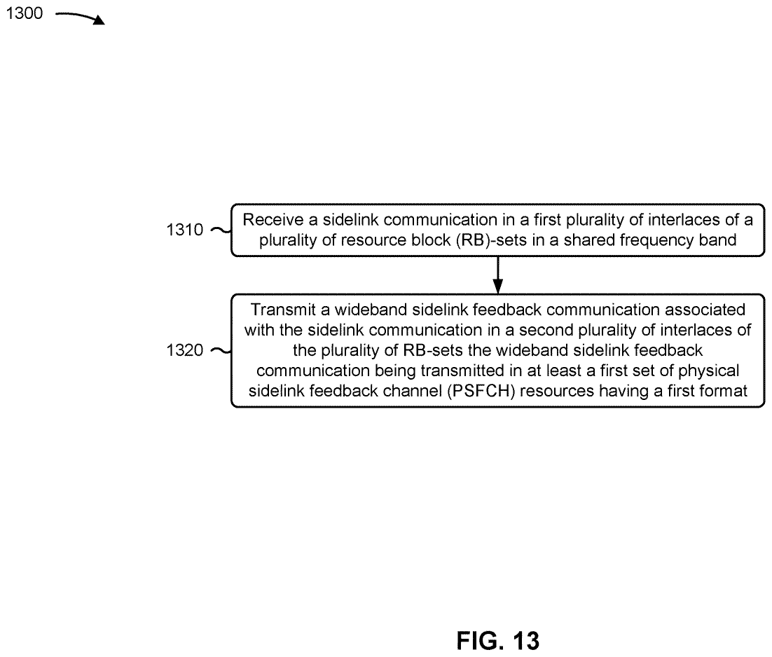

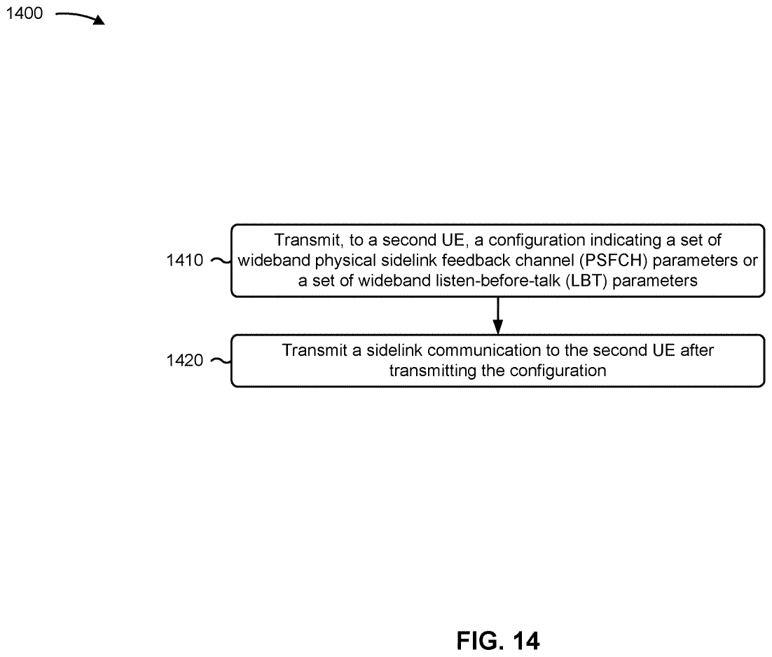

The controller/processor 240 of the network node 110, the controller/processor 280 of the UE 120, and/or any other component(s) of FIG. 2 may perform one or more techniques associated with sidelink unlicensed (SL-U) wideband physical sidelink feedback channel (PSFCH) for PSFCH format 0 (PF0) or PSFCH format 2 (PF2), as described in more detail elsewhere herein. For example, the controller/processor 240 of the network node 110, the controller/processor 280 of the UE 120, and/or any other component(s) of FIG. 2 may perform or direct operations of, for example, process 1200 of FIG. 12, process 1300 of FIG. 13, process 1400 of FIG. 14, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1200 of FIG. 12, process 1300 of FIG. 13, process 1400 of FIG. 14 and/or other processes as described herein. In some examples, executing instructions may include running the instructions, converting the instructions, compiling the instructions, and/or interpreting the instructions, among other examples.

In some aspects, the UE 120 includes means for receiving a plurality of RB-set specific configurations, each RB-set specific configuration corresponding to a respective RB-set from a plurality of RB-sets in a shared frequency band, wherein each RB-set specific configuration of the plurality of RB-set specific configurations indicates at least one of a first set of PSFCH resources having a first format or a second set of PSFCH resources having a second format that is different from the first format; means for receiving a sidelink communication in at least a first interlace of an RB-set included in the plurality of RB-sets; and/or means for transmitting a sidelink feedback communication associated with the sidelink communication in at least a second interlace of the RB-set, wherein the sidelink feedback communication is transmitted based at least in part on an RB-set specific configuration associated with the RB-set. In some aspects, the UE 120 includes means for receiving a sidelink communication in a first plurality of interlaces of a plurality of RB-sets in a shared frequency band; and/or means for transmitting a wideband sidelink feedback communication associated with the sidelink communication in a second plurality of interlaces of the plurality of RB-sets, the wideband sidelink feedback communication being transmitted in at least a first set of PSFCH resources having a first format. In some aspects, the UE 120 includes means for transmitting, to a second UE, a configuration indicating a set of wideband PSFCH parameters or a set of wideband LBT parameters; and/or means for transmitting a sidelink communication to the second UE after transmitting the configuration. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

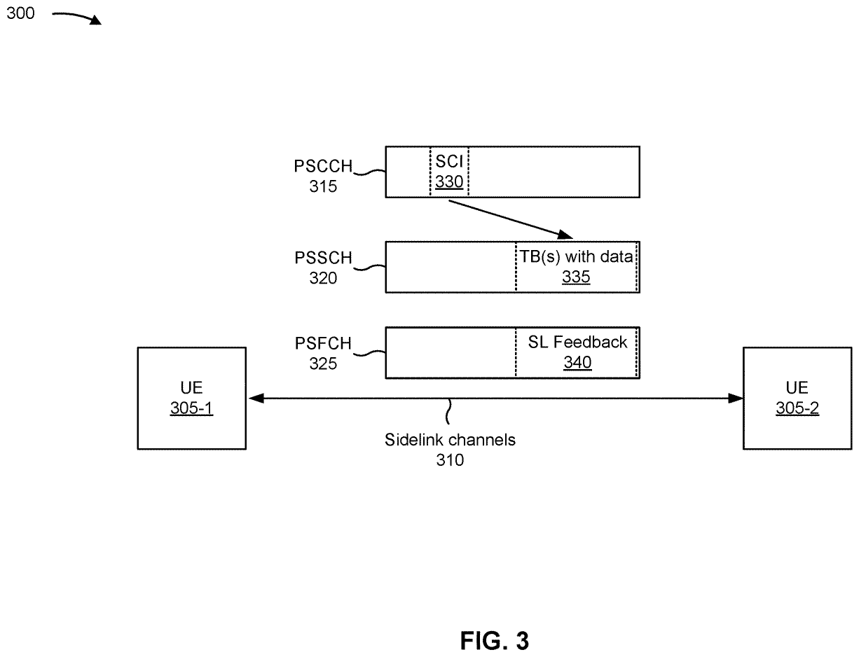

FIG. 3 is a diagram illustrating an example 300 of sidelink communications, in accordance with the present disclosure.

As shown in FIG. 3, a first UE 305-1 may communicate with a second UE 305-2 (and one or more other UEs 305) via one or more sidelink channels 310. The UEs 305-1 and 305-2 may communicate using the one or more sidelink channels 310 for P2P communications, D2D communications, V2X communications (e.g., which may include V2V communications, V2I communications, and/or V2P communications) and/or mesh networking. In some aspects, the UEs 305 (e.g., UE 305-1 and/or UE 305-2) may correspond to one or more other UEs described elsewhere herein, such as UE 120. In some aspects, the one or more sidelink channels 310 may use a PC5 interface and/or may operate in a high frequency band (e.g., the 5.9 GHz band). Additionally, or alternatively, the UEs 305 may synchronize timing of transmission time intervals (TTIs) (e.g., frames, subframes, slots, or symbols) using global navigation satellite system (GNSS) timing.

As further shown in FIG. 3, the one or more sidelink channels 310 may include a physical sidelink control channel (PSCCH) 315, a physical sidelink shared channel (PSSCH) 320, and/or a PSFCH 325. The PSCCH 315 may be used to communicate control information, similar to a physical downlink control channel (PDCCH) and/or a physical uplink control channel (PUCCH) used for cellular communications with a network node 110 via an access link or an access channel. The PSSCH 320 may be used to communicate data, similar to a physical downlink shared channel (PDSCH) and/or a physical uplink shared channel (PUSCH) used for cellular communications with a network node 110 via an access link or an access channel. For example, the PSCCH 315 may carry sidelink control information (SCI) 330, which may indicate various control information used for sidelink communications, such as one or more resources (e.g., time resources, frequency resources, and/or spatial resources) where a transport block (TB) 335 may be carried on the PSSCH 320. The TB 335 may include data. The PSFCH 325 may be used to communicate sidelink feedback 340, such as hybrid automatic repeat request (HARQ) feedback (e.g., acknowledgement or negative acknowledgement (ACK/NACK) information), transmit power control (TPC), and/or a scheduling request (SR).

Although shown on the PSCCH 315, in some aspects, the SCI 330 may include multiple communications in different stages, such as a first stage SCI (SCI-1) and a second stage SCI (SCI-2). The SCI-1 may be transmitted on the PSCCH 315. The SCI-2 may be transmitted on the PSSCH 320. The SCI-1 may include, for example, an indication of one or more resources (e.g., time resources, frequency resources, and/or spatial resources) on the PSSCH 320, information for decoding sidelink communications on the PSSCH, a quality of service (QOS) priority value, a resource reservation period, a PSSCH DMRS pattern, an SCI format for the SCI-2, a beta offset for the SCI-2, a quantity of PSSCH DMRS ports, and/or an MCS. The SCI-2 may include information associated with data transmissions on the PSSCH 320, such as a HARQ process identity (ID), a new data indicator (NDI), a source identifier, a destination identifier, and/or a channel state information (CSI) report trigger.

In some aspects, the one or more sidelink channels 310 may use resource pools. For example, a scheduling assignment (e.g., included in SCI 330) may be transmitted in subchannels using specific resource blocks (RBs) across time. In some aspects, data transmissions (e.g., on the PSSCH 320) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE 305 may operate using a sidelink transmission mode (e.g., Mode 1) where resource selection and/or scheduling is performed by a network node 110 (e.g., a base station, a CU, or a DU). For example, the UE 305 may receive a grant (e.g., in downlink control information (DCI) or in a radio resource control (RRC) message, such as for configured grants) from the network node 110 (e.g., directly or via one or more network nodes) for sidelink channel access and/or scheduling. In some aspects, a UE 305 may operate using a transmission mode (e.g., Mode 2) where resource selection and/or scheduling is performed by the UE 305 (e.g., rather than a network node 110). In some aspects, the UE 305 may perform resource selection and/or scheduling by sensing channel availability for transmissions. For example, the UE 305 may measure an RSSI parameter (e.g., a sidelink-RSSI (S-RSSI) parameter) associated with various sidelink channels, may measure an RSRP parameter (e.g., a PSSCH-RSRP parameter) associated with various sidelink channels, and/or may measure an RSRQ parameter (e.g., a PSSCH-RSRQ parameter) associated with various sidelink channels, and may select a channel for transmission of a sidelink communication based at least in part on the measurement(s).

Additionally, or alternatively, the UE 305 may perform resource selection and/or scheduling using SCI 330 received in the PSCCH 315, which may indicate occupied resources and/or channel parameters. Additionally, or alternatively, the UE 305 may perform resource selection and/or scheduling by determining a channel busy ratio (CBR) associated with various sidelink channels, which may be used for rate control (e.g., by indicating a maximum number of resource blocks that the UE 305 can use for a particular set of subframes).

In the transmission mode where resource selection and/or scheduling is performed by a UE 305, the UE 305 may generate sidelink grants, and may transmit the grants in SCI 330. A sidelink grant may indicate, for example, one or more parameters (e.g., transmission parameters) to be used for an upcoming sidelink transmission, such as one or more resource blocks to be used for the upcoming sidelink transmission on the PSSCH 320 (e.g., for TBs 335), one or more subframes to be used for the upcoming sidelink transmission, and/or an MCS to be used for the upcoming sidelink transmission. In some aspects, a UE 305 may generate a sidelink grant that indicates one or more parameters for semi-persistent scheduling (SPS), such as a periodicity of a sidelink transmission. Additionally, or alternatively, the UE 305 may generate a sidelink grant for event-driven scheduling, such as for an on-demand sidelink message.

In some aspects, the techniques and apparatuses described herein associated with an SL-U wideband PSFCH for capacity enhanced PF0 or PF2 may be applied with respect to sidelink communication as described with respect to FIG. 3.

As indicated above, FIG. 3 is provided as an example. Other examples may differ from what is described with respect to FIG. 3.

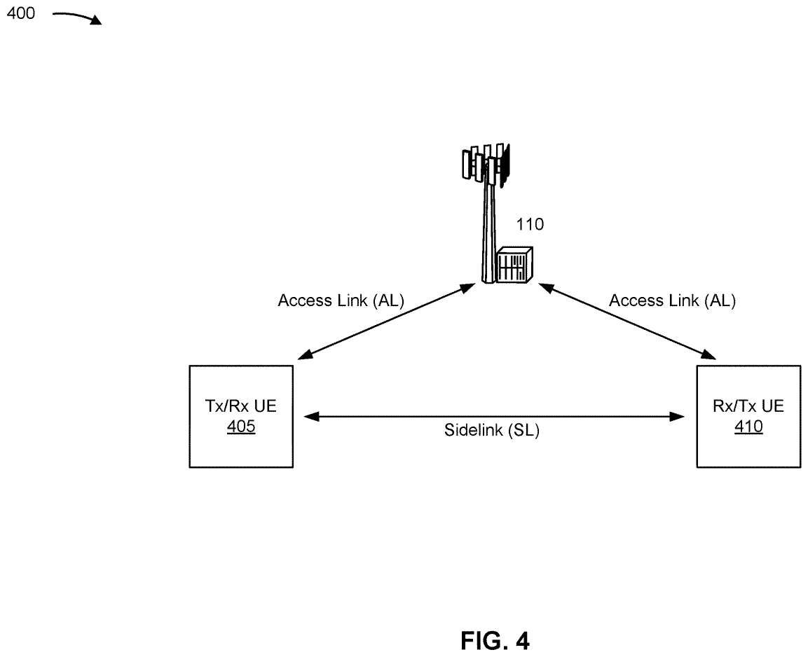

FIG. 4 is a diagram illustrating an example 400 of sidelink communications and access link communications, in accordance with the present disclosure.

As shown in FIG. 4, a transmitter (Tx)/receiver (Rx) UE 405 and an Rx/Tx UE 410 may communicate with one another via a sidelink, as described above in connection with FIG. 3. As further shown, in some sidelink modes, a network node 110 may communicate with the Tx/Rx UE 405 (e.g., directly or via one or more network nodes), such as via a first access link. Additionally, or alternatively, in some sidelink modes, the network node 110 may communicate with the Rx/Tx UE 410 (e.g., directly or via one or more network nodes), such as via a first access link. The Tx/Rx UE 405 and/or the Rx/Tx UE 410 may correspond to one or more UEs described elsewhere herein, such as the UE 120 of FIG. 1. Thus, a direct link between UEs 120 (e.g., via a PC5 interface) may be referred to as a sidelink, and a direct link between a network 110 and a UE 120 (e.g., via a Uu interface) may be referred to as an access link. Sidelink communications may be transmitted via the sidelink, and access link communications may be transmitted via the access link. An access link communication may be either a downlink communication (from a network node 110 to a UE 120) or an uplink communication (from a UE 120 to a network node 110).

In some aspects, the techniques and apparatuses described herein associated with an SL-U wideband PSFCH for capacity enhanced PF0 or PF2 may be applied with respect to sidelink communication and access link communications as described with respect to FIG. 4.

As indicated above, FIG. 4 is provided as an example. Other examples may differ from what is described with respect to FIG. 4.

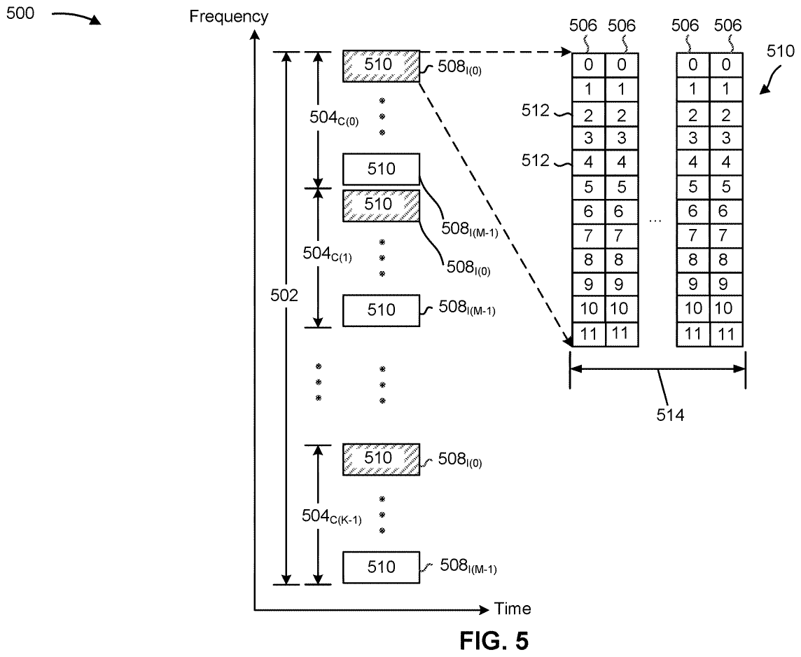

FIG. 5 illustrates a sidelink communication scheme 500 using a frequency-interlaced waveform, in accordance with the present disclosure. The scheme 500 may be employed by network nodes such (e.g., network nodes 110) and UEs (e.g., UEs 120, UEs 305, UEs 405/410, or the like) to communicate over a frequency band 502, which may be a shared radio frequency band or an unlicensed band. In FIG. 5, the x-axis represents time in some arbitrary units, and the y-axis represents frequency in some arbitrary units. The frequency band 502 may, for example, have a bandwidth of approximately 10 megahertz (MHz) or approximately 20 MHz and a subcarrier spacing (SCS) of approximately 5 kilohertz (kHz), approximately 30 kHz, or approximately 20 kHz. The frequency band 502 may be located at any suitable frequencies. In some aspects, the frequency band 502 may be located at approximately 3.5 GHZ, 6 GHz, or 60 GHz. The scheme 500 allocates resources for sidelink communications between UEs in units of frequency interlaces 508.

The frequency interlaces are shown as 508_{I(0)} to 508_{I(M-1)}, where M is a positive integer. Each frequency interlace 508_{I(i)} may include K plurality of RBs 510 (evenly) spaced over the frequency band 502, where K is a positive integer and i is a value between from 0 to M−1. In other words, the RBs 510 in a particular frequency interlace 508_{I(i)} are spaced apart from each other by at least one other RB 510. The frequency interlace 508_{I(0)} as shown comprises RBs 510 from clusters 504_{C(0)} to 504_{C(K-1)}. The values of K and M may vary based on several factors, such as a bandwidth, an SCS, and/or a power spectral density (PSD) limitation of the frequency band 502. In an example, a network node 110 may assign the frequency interlace 508_{I(0)} for sidelink communications between a pair of UEs 120 and may assign the frequency interlace 508_{I(1)} for sidelink communications between another pair of UEs 120. The allocation of the frequency interlace 508_{I(0)} are shown as patterned boxes in FIG. 5. In some other examples, the network node 110 may assign multiple frequency interlaces 508 (e.g., frequency interlaces 508_{I(0)} and 508_{I(1)} for sidelink communications between a pair of UEs.

A group of M localized RBs 510 forms a cluster 504. As shown, the frequency interlaces 508_{I(0)} to 508_{I(M-1)} form K clusters 504_{C(0)} to 504_{C(K-1)}. Each RB 510 may span approximately twelve contiguous subcarriers 512 in frequency and a time period 514. In the example shown in FIG. 5, the subcarriers 512 are indexed from 0 to 11. The subcarriers 512 can also be referred to as resource elements (REs). The time period 514 may span any suitable number of OFDM symbols 506. In some aspects, the time period 514 may correspond to one TTI, which may include approximately fourteen OFDM symbols 506.

The number of clusters 504 or the value of K may be dependent on the amount of frequency distribution required to maintain a certain bandwidth occupancy. As an example, the scheme 500 may divide the frequency band 502 into ten clusters 504 (e.g., K=10) and distribute an allocation over the ten clusters 504 to increase a frequency occupancy of the allocation. In an aspect, the frequency band 502 may have a bandwidth of approximately 20 MHz and each subcarrier 512 may span approximately 15 kHz in frequency. In such an aspect, the frequency band 502 may include approximately ten frequency interlaces 508 (e.g., M=10). For example, an allocation may include one frequency interlace 508 having ten distributed or equally spaced RBs 510. Compared to an allocation with a single RB or ten localized RBs, the interlaced allocation with the ten distributed RBs 510 allows a UE to transmit with a higher bandwidth occupancy.

In another aspect, the frequency band 502 may have a bandwidth of approximately 10 MHz and each subcarrier 512 may span approximately 15 kHz in frequency. In such an aspect, the frequency band 502 may include five frequency interlaces 508 (e.g., M=5). Similarly, an allocation may include one frequency interlace 508 having ten distributed RBs 510. The interlaced allocation with the ten distributed RBs may allow for a wider bandwidth occupancy than an allocation with a single RB or ten localized RBs.

In another aspect, the frequency band 502 may have a bandwidth of approximately 20 MHz and each subcarrier 512 may span approximately 30 kHz in frequency. In such an aspect, the frequency band 502 may include five frequency interlaces 508 (e.g., M=5). Similarly, an allocation may include one frequency interlace 508 having ten distributed RBs 510. The interlaced allocation with the ten distributed RBs may allow for a wider bandwidth occupancy than an allocation with a single RB or ten localized RBs.

In some aspects, the RBs 510 are physical resource blocks (PRBs) and each frequency interlace 508 may include PRBs uniformly spaced in the frequency band 502.

In the scheme 500, sidelink communications over an assigned frequency interlace 508 (e.g., the frequency interlace 508_{I(0)} may include PSSCH communications (e.g., the PSSCH communication 320) and PSCCH communication (e.g., the PSCCH communication 315). Thus, in the scheme 500, sidelink transmissions may have a frequency-interlaced waveform. If the frequency band 502 is a shared radio frequency band or an unlicensed band, then a UE may be required to perform a listen-before-talk (LBT) procedure prior to transmitting in an assigned frequency interlace 508. When a result of the LBT procedure is a pass, the UE may proceed to transmit PSSCH data and/or PSCCH control information to another UE using the assigned frequency interlace 508. The PSSCH control information may be transmitted in the form of SCI, which may be similar to the PDCCH DCI transmitted by a network node to a UE. When the result of the LBT procedure is a fail, the UE may refrain from transmitting in the assigned frequency interlace. To reduce LBT delay, the scheme 500 may in some scenarios configure the UE to multiplex PSSCH and PSCCH in the same frequency interlace 508 (e.g., using a frequency division multiplexing (FDM) scheme and/or a time division multiplexing (TDM) scheme).

In some aspects, the techniques and apparatuses described herein associated with an SL-U wideband PSFCH for capacity enhanced PF0 or PF2 may be applied in association with sidelink communications use a frequency-interlaced waveform as described with respect to FIG. 5.

As indicated above, FIG. 5 is provided as an example. Other examples may differ from what is described with respect to FIG. 5.

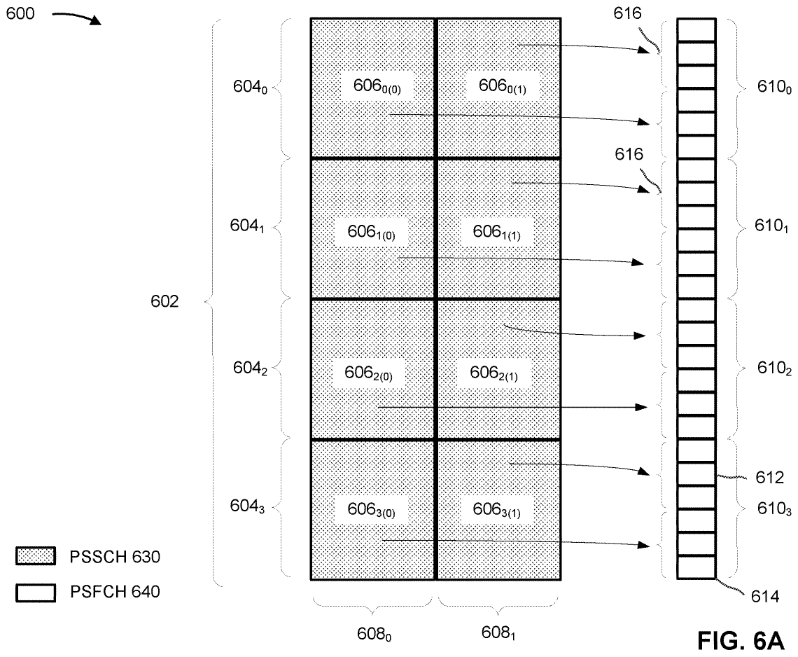

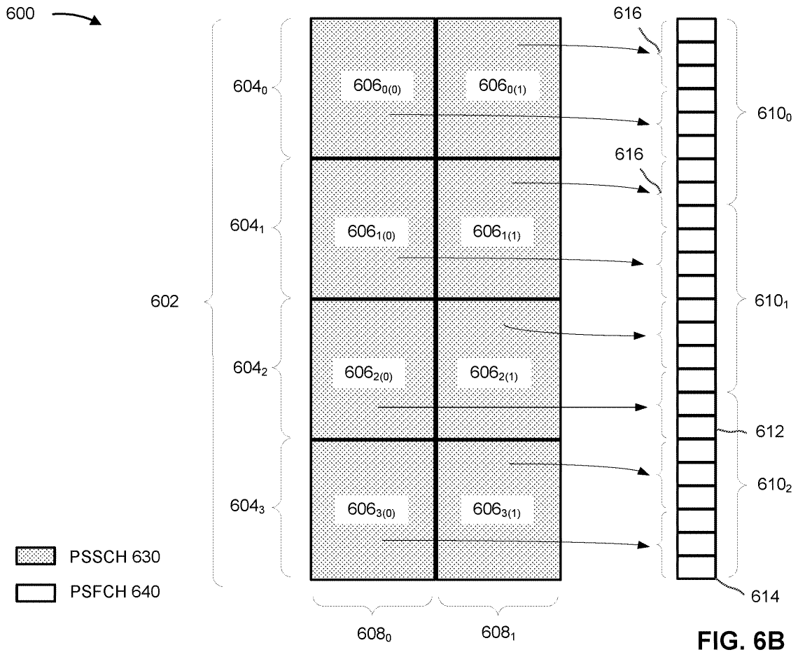

FIGS. 6A and 6B are diagrams illustrating examples associated with mapping PSSCH communications to PSFCH resources, in accordance with the present disclosure.

A UE (e.g., a UE 120, a UE 305, a UE 405, or the like) may be configured with sidelink feedback resources for communicating a PSFCH communication indicating whether a PSSCH communication was received. For example, the UE may be configured with PSFCH resources for communicating a PSFCH, such as HARQ ACK/NACK feedback associated with improving communication reliability. In this regard, a first UE and a second UE may communicate PSSCH data (e.g., PSSCH communication) using HARQ and communicate HARQ ACK/NACK feedback using an assigned frequency interlace. For example, the first UE may transmit a PSSCH communication carrying PSSCH data to the second UE over a sidelink interface. The PSSCH data packet may be transmitted in the form of a TB. If the second UE receives PSSCH data successfully, then the second UE may transmit a PSFCH communication carrying a HARQ ACK to the first UE using an assigned frequency interlace. Conversely, if the second UE fails to receive the PSSCH communication successfully, then the second UE may transmit a PSFCH carrying a HARQ NACK to the first UE using the assigned frequency interlace. Upon receiving a HARQ NACK from the second UE, the first UE may retransmit the PSSCH data in another PSSCH communication.

In some scenarios, a plurality of PSFCH communications are transmitted simultaneously, where each PSFCH communication corresponds to a respective PSSCH communication. Accordingly, the second UE transmitting the PSFCH communications may map each PSSCH communication to a respective PSFCH resource according to a mapping scheme. In some aspects, a PSFCH resource may include or be defined in terms of RB-sets, interlaces, and/or cyclic shift (CS) pairs.

With reference to FIG. 6A, a first UE may communicate, with a second UE, a plurality of PSSCH communications 606ᵢ₍ⱼ₎. For example, in some aspects, the first UE may communicate a plurality of TBs carrying PSSCH data in corresponding PSSCH resources 630. The PSSCH resources 630 include a plurality of PSSCH interlaces 604ᵢ in one or more RB-sets 602. Although a single RB-set 602 is shown in FIGS. 6A and 6B, it will be understood that the PSSCH communications 606ᵢ₍ⱼ₎ may span more than one RB-set, such as two RB-sets, three RB-sets, four RB-sets, eight RB-sets, and/or the like. In some aspects, each PSSCH communication 606ᵢ₍ⱼ₎ may correspond to one of a plurality of interlaces of RBs 604ᵢ. The interlaces 604; are illustrated as logical interlaces. Each interlace 604ᵢ of RBs may include a plurality of RBs spaced from each other by at least one other RB in the RB-set 602. In the illustrated examples, the RB-set 602 includes four PSSCH interlaces 604ᵢ of RBs. The PSFCH resources 640 may correspond to the same RB-set 602. In other aspects, the PSFCH resources 640 may include one or more other RB-sets instead of or in addition to the PSSCH RB-set 602.

In the example shown in FIG. 6A, the RB-set 602 includes four PSSCH interlaces 604; of RBs. A plurality of PSSCH communications 606ᵢ₍ⱼ₎ are distributed among the interlaces 604; and in a first slot 6080 and a second slot 6081. Accordingly, each PSSCH communication 606ᵢ₍ⱼ₎ corresponds to an interlace i and a slot j. Thus, the suffixes provided for each PSSCH communication 606ᵢ₍ⱼ₎ in FIG. 6A may indicate both of the interlace index i and the slot index j. For example, the PSSCH communication 606₂₍₀₎ may correspond to interlace index 2 and slot index 0. The example 600 also includes a plurality of PSFCH resources 640 including four PSFCH interlaces 610ₖ distributed within the RB-set 602. In this regard, the PSFCH resources 640 may use the same RB-set 602 used for the PSSCH resources 630. In other aspects, the PSFCH resources 640 may use a different RB-set or RB-set configuration than the PSSCH resources 630. The PSFCH resources 640 include the same number of interlaces 610ₖ as the PSSCH resources 630 in the scheme 600. Accordingly, the example 600 may include mapping the PSSCH communications 606 from one PSSCH interlace 604ᵢ in the RB-set 602 to a corresponding PSFCH interlace 610ₖ in the RB-set 602. In some aspects, the PSSCH communications 606ᵢ₍ⱼ₎ may span more than interlace 604 and/or more than one RB-set 602. Accordingly, in some aspects, the scheme 600 may include mapping the PSSCH communications 606ᵢ₍ⱼ₎ from one set of RB-sets 602 to a corresponding set of RB-sets of the PSFCH resources 640. In some aspects, the PSSCH communications 606ᵢ₍ⱼ₎ may span a plurality of RB-sets and the example 600 may include mapping the PSSCH communications 606ᵢ₍ⱼ₎ from the plurality of RB-sets to PSFCH resources within a first RB-set of the plurality of RB-sets. In another aspect, the example 600 may include mapping the PSSCH communications 606 spanning the plurality of RB-sets to the same plurality of RB-sets within the PSFCH resources 640. In another aspect, the scheme 600 may include mapping the PSSCH communications 606ᵢ₍ⱼ₎ from one set of PSSCH interlaces to a corresponding set of PSFCH interlaces. In some aspects, each PSSCH interlace 604; may be associated with an interlace index i and each PSFCH interlace 610ₖ may be associated with an interlace index k. In some aspects, the indexes of the PSSCH interlaces 604ᵢ may be the same as the indexes of the PSFCH interlaces 610ₖ. In other aspects, of the indexes of the PSSCH interlaces may be different from the indexes of the PSFCH interlaces. In other aspects, a single set of interlace indexes may be used for both of the PSSCH resources 630 and the PSFCH resources 640.

In some aspects, the PSSCH communications 606ᵢ₍ⱼ₎ are mapped to the PSFCH resources 640 based on the RB-set 602 and the interlace 604ᵢ. For example, the PSSCH communications 606₀₍₀₎ and 606₀₍₁₎ map to the PSFCH interlace 610₀ in the RB-set 602. In the example of FIG. 6A in which the PSFCH resources 640 include the same number of logical interlaces 610 within an RB-set 602, the PSSCH communications 606 may be mapped to the PSFCH resources 640 further based on the slot index 608ⱼ. In this regard, each PSFCH interlace 610ₖ may include a plurality of CS pair sets 616, with each CS pair set comprising one or more CS pairs. For example, the CS pairs include the CS pairs 612, 614. The PSSCH communications 606ᵢ₍ⱼ₎ may be mapped to one or more CS pairs in the PSFCH resources 640.

In some aspects, the mapping may include a one-to-one mapping from the PSSCH interlace and slot index to the corresponding PSFCH interlace and a corresponding CS pair set within the PSFCH period. In one aspect, the PSSCH leading RB-set and interlace may be the interlace and RB-set which carry or include the SCI-1 scheduling the PSSCH communication. If the PSSCH resources 630 include the same number of RB-sets and the same number of interlaces as the PSFCH resources 640, the mapping may include a one-to-one mapping between the PSSCH interlace and RB-set, and the PSFCH interlace in the same RB-set.

With reference to FIG. 6B, the number of PSFCH interlaces within an RB-set may in some aspects be smaller than the number of PSSCH interlaces. The example 650 in FIG. 6B includes PSSCH resources 630 having four interlaces 604 within the RB-set 602. The PSFCH resources 640 include three interlaces 610 within the RB-set 602. Accordingly, in the example 650, the UE may partition a total number of CS pairs in the PSFCH resources 640 and map the PSSCH communications 606 based on a leading PSSCH interlace to a corresponding partitioned CS pair set. In this regard, although the number of PSFCH interlaces may be smaller than or otherwise different than the number of PSSCH interlaces, the UE may map a PSSCH leading RB-set or RB-sets to a corresponding PSFCH RB-set or RB-sets.

In some aspects, there may be 2, 3, 4, 6, and/or any other suitable number of CS pairs within an interlace of RBs. In this regard, FIGS. 6A and 6B show the PSFCH resources 640 having three CS pairs in each CS pair set, with six CS pairs in each PSFCH interlace 610. Accordingly, the UE may map a PSSCH from the first slot to a first CS pair set in the interlace and a PSSCH from a second slot to a second CS pair set in the interlace.

In some aspects, a UE may receive a wideband SL communication occupying resources in more than one RB-set. For example, in some aspects, a PSSCH communication may be associated with an interlace of RBs within two or more RB-sets. The UE may receive the wideband PSSCH communication during a channel occupancy time (COT), and may transmit sidelink feedback (e.g., an ACK/NACK) in PSFCH resources in the same COT. In some aspects, the COT may be continued for the COT-initiating UE in the RB-sets in which the sidelink feedback is transmitted. However, in some aspects, the COT may terminate in the RB-sets in which PSSCH was transmitted but PSFCH was not transmitted. In some aspects, the receiving UE may transmit a PSFCH waveform in more than one RB-set of the RB-sets in which the PSSCH was transmitted, so that the COT may be continued for some or all of the PSSCH RB-sets.

In some aspects, the techniques and apparatuses described herein associated with an SL-U wideband PSFCH for capacity enhanced PF0 or PF2 may be applied in association with mapping PSSCH communications to PSFCH resources as described with respect to FIG. 6.

As indicated above, FIGS. 6A and 6B are provided as examples. Other examples may differ from what is described with respect to FIGS. 6A and 6B.

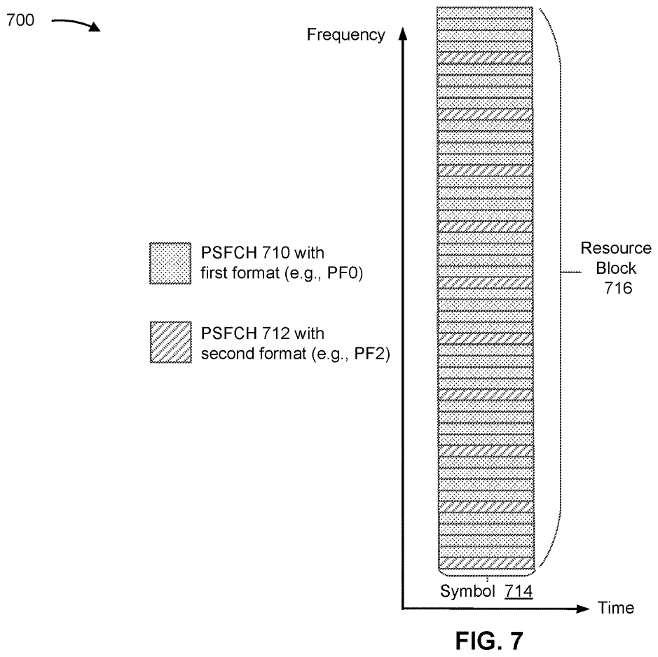

FIG. 7 illustrates an example of resources 700 associated with frequency division multiplexed PSFCH transmissions, in accordance with the present disclosure. The resources 700 may be implemented by aspects of the wireless communications network 100. For example, the resources 700 may be implemented for communications by one or more UEs, (e.g., UEs 120, UEs 305, UEs 405, or the like). In FIG. 7, the x-axis represents time in some arbitrary units, the y-axis represents frequency in some arbitrary units.

In some aspects, a first sidelink UE (e.g., a UE 120, a UE 305, a UE 405) may receive, from a second sidelink UE (e.g., a UE 120, a UE 305, a UE 405), a configuration associated with multiplexing a PSFCH 710 having a first format (e.g., PF0) with a PSFCH 712 having a second format (e.g., PF2). In some aspects, the second format may be different from the first format. In some aspects, the first sidelink UE may receive the configuration from the second sidelink UE via SCI, an RRC message, a medium access control (MAC) control element, a PSCCH communication, a PSSCH communication, or the like. Additionally or alternatively, the first sidelink UE may operate in sidelink mode 1 and receive the configuration from a network unit (e.g., a network node 110) via an RRC message, a MAC control element, a PDSCH message, a PDCCH message, or the like.

In some aspects, the configuration may indicate a resource pool associated with at least one of the first format (e.g., PF0) or the second format (e.g., PF2). In some aspects, the configuration received by the first sidelink UE may indicate a resource pool associated with at least one of the first format or the second format. The resource pool may indicate the time resources (e.g., symbol 714, slots) associated with the first format and/or the second format.

The resource pool may indicate the frequency resources (e.g., resource block 716, a frequency interlace, an orthogonal cover code (OCC) index, an RE, a subchannels, a bandwidth part, a frequency spectrum, or the like) associated with the first format and/or the second format. The first UE may receive an indicator from the second sidelink UE indicating the resources to use for transmitting the PSFCH 710 and/or the second PSFCH. In this regard, the first UE may receive the indicator from the second sidelink UE via SCI (e.g., SCI-1 and/or SCI-2). For example, a codepoint (e.g., an index) in the SCI may indicate (e.g., dynamically indicate) a set of time/frequency resources from the resource pool that the first sidelink UE should use to transmit the PSFCH 710 and/or the PSFCH 712.

In some aspects, the first sidelink UE may receive one or more TBs from the second sidelink UE. In this regard, the first sidelink UE may receive the one or more TB(s) via a PSSCH. The first sidelink UE may transmit, to the second sidelink UE based on the configuration, a PSFCH communication (e.g., an ACK/NACK) associated with the one or more TBs received from the second sidelink UE. In this regard, the first sidelink UE may transmit the PSFCH communication to the second sidelink UE via the PSFCH 710 having the first format multiplexed with the second PSFCH having the second format.

In some aspects, the first format may be multiplexed in the frequency domain with the second format. For example, as shown in FIG. 7, the PSFCH 710 having the first format may be frequency interlaced with the PSFCH 712 having the second format. In one example, the frequency interlace may repeat over five frequency ranges (e.g., over five subchannels) or over another number of subchannels. For example, the PSFCH 710 having PF0 may occupy 7 contiguous subchannels with the PSFCH 712 having PF2 occupying a single subchannel adjacent to the 7 contiguous subchannels. For example, the PSFCH 712 having PF2 may occupy subchannel index (0) while the PSFCH 710 having PF0 may occupy subchannel indexes (1) to (4) and the PSFCH 712 having PF2 may occupy subchannel index (5) while the PSFCH 710 having PF0 may occupy subchannel indexes (6) to (9), and so on. Other interlace structures may be used in practice. In some aspects, the interlace may be repeated over resource block 716 and/or over a bandwidth part (e.g., a 5 MHz bandwidth part, a 10 MHz bandwidth part, a 20 MHz bandwidth part, a 40 MHz bandwidth part, a 80 MHz bandwidth part, or the like). In some aspects, the first/second format frequency interlace (e.g., the PF0/PF2 frequency interlace) may be transmitted over a single symbol 714 (e.g., symbol index 12 or other symbol index) and/or over another number of symbols (e.g., any of symbol indexes 0 to 13).

In some aspects, the techniques and apparatuses described herein associated with an SL-U wideband PSFCH for capacity enhanced PF0 or PF2 may be applied in association with frequency division multiplexed PSFCH transmissions as described with respect to FIG. 7.

As indicated above, FIG. 7 is provided as an example. Other examples may differ from what is described with respect to FIG. 7.

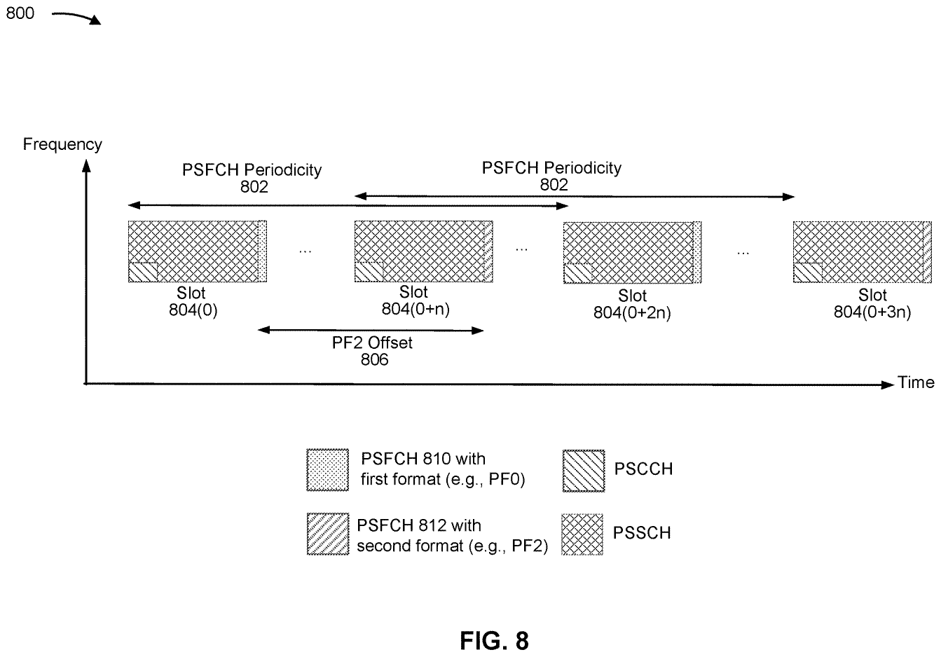

FIG. 8 illustrates an example of resources 800 associated with time division multiplexed PSFCH transmissions, in accordance with the present disclosure. The resources 800 may be implemented by aspects of the wireless communications network 100. For example, the resources 800 may be implemented for communications by one or more UEs, (e.g., UEs 120, UEs 305, UEs 405, or the like). In FIG. 8, the x-axis represents time in some arbitrary units, the y-axis represents frequency in some arbitrary units.

In some aspects, a first sidelink UE may receive a configuration indicating a PSFCH periodicity 802. The PSFCH periodicity 802 may indicate the periodicity at which the first sidelink UE should transmit a PSFCH 810 having a first format (e.g., PF0) and/or a PSFCH 812 having a second format (e.g., PF2). In some aspects, the first sidelink UE may dynamically receive the configuration to multiplex the first and second PSFCH formats. For example, the configuration may indicate the first sidelink UE is to transmit the PSFCH 810 without multiplexing the PSFCH 810 with the PSFCH 812. The first sidelink UE may then receive an updated configuration (e.g., via an RRC reconfiguration message) indicating the first sidelink UE is to multiplex the PSFCH 810 with the PSFCH 812. The first sidelink UE may receive updated configurations indicating whether the first sidelink UE is to transmit the PSFCH 810 without multiplexing the PSFCH 810 with the PSFCH 812 or whether the first sidelink UE is to transmit the PSFCH 810 multiplexed the PSFCH 812. The updated configuration may be based, for example, on an amount of TBs received by the first sidelink UE within a time period. Additionally or alternatively, the updated configuration indicating the first sidelink UE should multiplex the PSFCH 810 with the PSFCH 812 may be valid for a time period after the first sidelink UE receives the updated configuration. After the time period expires, the first sidelink UE may revert to transmitting a PSFCH 810 without multiplexing the PSFCH 810 with the PSFCH 812.

In some aspects, the PSFCH 810 having the first format (e.g., PF0) may be multiplexed in the time domain with the PSFCH 812 having the second format (e.g., PF2). In this regard, the first sidelink UE may transmit the PSFCH 810 in one or more symbols (e.g., a plurality of contiguous symbols) at the PSFCH periodicity 802 indicated by the configuration. The PSFCH periodicity 802 may be based on an integer number of slots or sub-slots (e.g., 1, 2, 3, 4, or more slots or sub-slots). For example, the first sidelink UE may transmit the PSFCH 810 having the first format in a single symbol in slot 804(0). The first sidelink UE may transmit another PSFCH 810 having the first format in a single symbol in slot 804(0+2n) based on the PSFCH periodicity 802. The PSFCH periodicity 802 may be based on an integer number (e.g., n) of slots. The first sidelink UE may transmit the PSFCH 812 having the second format in one or more symbols (e.g., a plurality of contiguous symbols) in slots 804(0+n) and slot 804(0+3) at the PSFCH periodicity 802. However, the PSFCH 812 having the second format may be transmitted at an offset in time from the PSFCH 810 having the first format. For example, the PSFCH 812 having the second format may be transmitted at a PF2 offset 806 from the PSFCH 810 having the first format based on a number of slots or sub-slots (e.g., 1, 2, 3, 4, or more slots or sub-slots offset from the PSFCH format 0 810).

In some aspects, the techniques and apparatuses described herein associated with an SL-U wideband PSFCH for capacity enhanced PF0 or PF2 may be applied in association with time division multiplexed PSFCH transmissions as described with respect to FIG. 8.

As indicated above, FIG. 8 is provided as an example. Other examples may differ from what is described with respect to FIG. 8.

A wireless communication may be configured to support sidelink communication that enables a wideband COT communication (e.g., a wideband PSSCH communication transmitted during a COT) to be transmitted by a transmitter UE over multiple RB-sets for reception by a receiver UE. In such a scenario, if a sidelink feedback communication (e.g., a PSFCH communication) is to be transmitted by the receiver UE during (e.g., in the middle of) the wideband COT communication, then a PSFCH should be wideband to enable the transmitter UE to resume transmission of the wideband COT communication after the PSFCH. To support such operation, the receiver UE may in some systems be configured to transmit a wideband PSFCH in one or more of the RB-sets occupied by the PSSCH. Here, for PSFCH format PF0, the receiver UE may map a PSFCH resource to a PSFCH interlace in all configured RB-sets in a data resource pool, and may transmit a (truncated) PSFCH waveform in the associated PSSCH RB-set(s). In some aspects, the receiver UE selects the same PSFCH interlace across all of the RB-sets, with the PSFCH interlace being determined based on the PSSCH allocation in one of the RB-sets or in a leading RB-set.

Further, an interlaced PSFCH waveform may be utilized in some systems to satisfy an occupied channel bandwidth (OCB) requirement or a power spectral density requirement for SL-U. However, an interlace RB (IRB)-based interlace waveform may not allow for sufficient UE multiplexing capacity. For example, an IRB-based interlace waveform may occupy 10 RB. Here, with 5 total interlaces for an SCS of 30 KHz and 6 CS pairs, one PSFCH symbol can multiplex only 30 UEs with a 50 RB bandwidth. Thus, the UE multiplexing capacity is 10 times less than that of a legacy PSFCH for a given bandwidth (e.g., since the interlaced waveform takes 10 RB versus taking 1 RB in the legacy PSFCH). Therefore, if a PSFCH instance is shared by multiple PSSCH receiver UEs (e.g., multiple receiver UEs receiving the PSSCH), one PSFCH symbol may have insufficient resources to enable receiver UEs to transmit PSFCH feedback For example, one PSFCH symbol may have only 30 resources in which PSFCH can be transmitted, but there be more than 30 receiver UEs that need to transmit PSFCH. A groupcast option 2 scenario-a scenario in which a transmitter UE can transmit to a high number of receivers and requires ACK/NACK from all of the receiver UEs-is one scenario in which such a limitation may be detrimental. One technique to address this UE capacity issue is to configure sidelink UEs such that each PSFCH communication occupies a common interlace and zero or one or more dedicated physical RBs. Another technique to address the UE capacity issue is to configure sidelink UEs such that each PSFCH communication occupies one or more dedicated physical RBs and one or more common physical RBs.

Further, as described above, different PSFCH formats may in some systems be frequency division multiplexed on different interlaces or may be time division multiplexed on different PSFCH instances, with some configured partitioning. For example, a PF0 interlace PSFCH (e.g., used to carry a one bit ACK/NACK) may be multiplexed (e.g., FDM or TDM) with a PF2 interlace (e.g., used to carry multiple ACK/NACK). In some aspects, PF0 and PF2 cannot be multiplexed in the same interlace and same PSFCH symbol, and PF0 PSFCH resources and PF2 PSFCH resources need to be orthogonal in time or frequency. Here, each link may configure a PF0/PF2 PSFCH resource pool with a respective partitioning.

As described above, to resolve the wideband COT communication continuation problem across a PSFCH communication, a PF0 PSFCH waveform may be repeated in all RB-sets occupied by a wideband COT communication. However, a wideband PSFCH needs to be defined for when a PF2 PSFCH is utilized. Further, if capacity enhanced PF0 is introduced, a wideband PSFCH needs to be defined for maintaining a wideband COT.

Some techniques and apparatuses described herein enable an SL-U wideband PSFCH for capacity enhanced PF0 or PF2. In some aspects, a UE may receive a plurality of RB-set specific configurations, where each RB-set specific configuration corresponds to a respective RB-set from a plurality of RB-sets in a shared frequency band, and each RB-set specific configuration indicates a first set of PSFCH resources having a first format or a second set of PSFCH resources having a second format. Here, the UE may receive a sidelink communication in at least a first interlace of an RB-set included in the plurality of RB-sets, and may transmit sidelink feedback communication associated with the sidelink communication in at least a second interlace of the RB-set and based at least in part on an RB-set specific configuration associated with the RB-set. In some aspects, a UE may receive a sidelink communication in a first plurality of interlaces of a plurality of RB-sets in a shared frequency band, and may transmit a wideband sidelink feedback communication associated with the sidelink communication in a second plurality of interlaces of the plurality of RB-sets, where the wideband sidelink feedback communication is transmitted in at least a first set of PSFCH resources having a first format. In some aspects, a UE may transmit, to another UE, a configuration indicating a set of wideband PSFCH parameters or a set of wideband LBT parameters, and may transmitting a sidelink communication to the other UE after transmitting the configuration. In some aspects, the techniques and apparatuses described herein enable a continuation of a wideband COT communication (e.g., a PSSCH communication) across a PSFCH communication for a scenario in which the PSFCH utilizes capacity enhance PF0 or PF2, thereby increasing network flexibility and improving sidelink communication reliability. Additional details are provided below.

FIGS. 9A and 9B are diagrams illustrating examples associated with an SL-U wideband PSFCH for capacity enhanced PF0 or PF2, in accordance with the present disclosure. As shown in FIG. 9A, an example 900 includes communication between a UE 120-1 and a UE 120-2. In some aspects, a UE 120 (e.g., the UE 120-1 or the UE 120-2) may correspond to a UE 305, a UE 405, a UE 410, or another device as described herein. In some aspects, the UE 120-1 and the UE 120-2 may be included in a wireless network, such as wireless network 100. The UE 120-1 and the UE 120-2 may communicate via a wireless access link, such as a sidelink (e.g., in the unlicensed spectrum).

As shown by reference 902, the UE 120-1 may receive a plurality of RB-set specific configurations. In some aspects, as indicated in FIG. 9A, the UE 120-1 may receive the plurality of RB-set specific configurations from the UE 120-2 (e.g., via a sidelink). Additionally, or alternatively, the UE 120-1 may receive the plurality of RB-set specific configurations from another device, such as a network node 110 (not shown).

An RB-set specific configuration is a configuration associated with a particular RB-set via which sidelink communications (e.g., a PSSCH communication) and/or sidelink feedback communication (e.g., a PSFCH communication) may be transmitted or received. In some aspects, each RB-set specific configuration corresponds to a respective RB-set from a plurality of RB-sets in a shared frequency band. For example, with reference to FIG. 9B, a first RB-set specific configuration of the plurality of RB-set specific configurations may correspond to an RB-set 0, a second RB-set specific configuration of the plurality of RB-set specific configurations may correspond to an RB-set 1, a third RB-set specific configuration of the plurality of RB-set specific configurations may correspond to an RB-set 2, and so on. Here, a given RB-set may correspond to an RB-set 602 described herein (e.g., with respect to FIGS. 6A and 6B). Thus, in some aspects, a given RB-set may include a PSSCH resource that corresponds to a plurality of PSSCH interlaces and a PSFCH resource that corresponds to a plurality of PSSCH interlaces (e.g., as described above with respect to FIGS. 6A and 6B).

In some aspects, each RB-set specific configuration indicates a first set of PSFCH resources having a first format or a second set of PSFCH resources having a second format that is different from the first format. In some aspects, the first format may be PF0 and the second format may be PF2. Alternatively, in some aspects, the first format may be PF2 and the second format may be PF0. As an example, with reference to FIG. 9B, an RB-set specific configuration associated with the RB-set 0 may indicate a set of PSFCH resources having the first format (e.g., PF0) and a second set of PSFCH having the second format (e.g., PF2). As another example, an RB-set specific configuration associated with the RB-set 1 may indicate a first set of PSFCH resources having the first format and a second set of PSFCH resources having the second format. As another example, an RB-set specific configuration associated with the RB-set 2 may indicate only a set of PSFCH resources having the first format (i.e., the second format may not be configured for RB-set 2). In this regard, in some aspects, the plurality of RB-set specific configurations may include an RB-set specific configuration that indicates a set of PSFCH resources having a single format (e.g., either PF0 or PF2).

In some aspects, as illustrated by the example shown in FIG. 9B, the plurality of RB-set specific configurations includes a first RB-set specific configuration that is different from a second RB-set specific configuration. That is, the configuration of PSFCH may differ among some RB-set specific configurations.

Returning to FIG. 9A, as shown by reference 904, the UE 120-2 may transmit, and the UE 120-1 may receive, a sidelink communication in at least a first interlace of an RB-set included in the plurality of RB-sets. For example, the UE 120-2 may transmit, and the UE 120-1 may receive, a PSSCH communication in a PSSCH resource corresponding to one or more PSSCH interlaces of RB-set 0.

As shown by reference 906, the UE 120-1 may transmit, and the UE 120-2 may receive, a sidelink feedback communication associated with the sidelink communication in at least a second interlace of the RB-set, where the sidelink feedback communication is transmitted based at least in part on an RB-set specific configuration associated with the RB-set. For example, the UE 120-1 may transmit, and the UE 120-2 may receive a PSFCH communication associated with the PSSCH communication in one or more PSFCH interlaces of the RB-set 0 (e.g., one or more PSFCH interlaces that map to the one or more PSSCH interlaces). Here, the UE 120-1 may transmit the PSFCH communication based at least in part on an RB-set specific configuration associated with the RB-set (e.g., such that the UE 120-1 transmits the PSFCH communication using the appropriate PSFCH format(s) as indicated by the RB-set specific configuration).

In some aspects, the RB-set specific configuration may enable a continuation of a wideband COT communication (e.g., a PSSCH communication) across a PSFCH communication in a scenario in which a PSFCH utilizes capacity enhance PF0 or PF2, thereby increasing network flexibility and improving sidelink communication reliability.

As indicated above, FIGS. 9A and 9B is provided as an example. Other examples may differ from what is described with respect to FIGS. 9A and 9B.

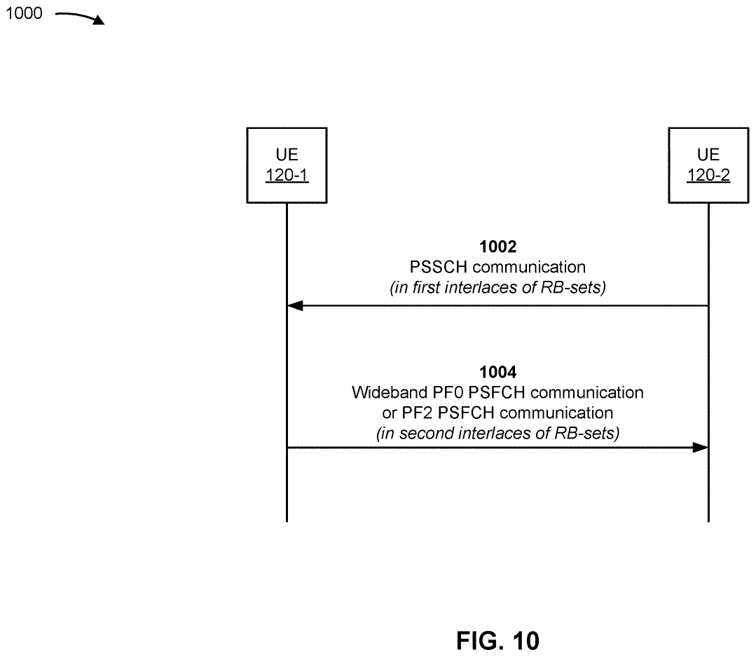

FIG. 10 is a diagram illustrating an example 1000 associated with an SL-U wideband PSFCH for capacity enhanced PF0 or PF2, in accordance with the present disclosure. As shown in FIG. 10, example includes communication between a UE 120-1 and a UE 120-2. In some aspects, a UE 120 (e.g., the UE 120-1 or the UE 120-2) may correspond to a UE 305, a UE 405, a UE 410, or another device as described herein. In some aspects, the UE 120-1 and the UE 120-2 may be included in a wireless network, such as wireless network 100. The UE 120-1 and the UE 120-2 may communicate via a wireless access link, such as a sidelink (e.g., in the unlicensed spectrum).

As shown by reference 1002, the UE 120-2 may transmit, and the UE 120-1 may receive, a sidelink communication in a first plurality of interlaces of a plurality of RB-sets in a shared frequency band. For example, the UE 120-2 may transmit, and the UE 120-1 may receive, a PSSCH communication in a PSSCH resource corresponding to one or more PSSCH interlaces of a first RB-set and a second RB-set.

As shown by reference 1004, the UE 120-1 may transmit, and the UE 120-2 may receive, a wideband sidelink feedback communication associated with the sidelink communication in a second plurality of interlaces of the plurality of RB-sets. For example, the UE 120-1 may transmit, and the UE 120-2 may receive, a PSFCH communication associated with the PSSCH communication in one or more PSFCH interlaces of the first RB-set and the second RB-set (e.g., one or more PSFCH interlaces that map to the one or more PSSCH interlaces). In some aspects, the UE 120-1 transmits the wideband sidelink feedback communication in at least a first set of PSFCH resources having a first format.

In some aspects, the first format is PF2. That is, in some aspects, the wideband sidelink feedback communication may be a wideband PSFCH communication having PF2. In some such aspects, each RB-set of the plurality of RB-sets utilizes the same RB-set configuration for PSFCH resources. That is, if the wideband sidelink feedback communication is a wideband PF2 PSFCH communication, then the plurality of RB-sets may in some aspects utilize the same RB-set configuration for PSFCH resources.

In some aspects, the UE 120-1 transmits the wideband sidelink feedback communication such that a waveform associated with the first format (e.g., PF2) spans the plurality of RB-sets. Here, the UE 120-1 may transmit the wideband sidelink feedback communication such that a DMRS spans the plurality of RB-sets (e.g., such that a long DMRS spans across all of the RB-sets). Further, in some such aspects, a payload of the wideband sidelink feedback communication is rate matched to the second plurality of interlaces or to RBs in the plurality of RB-sets.

In some aspects, the UE 120-1 transmits the wideband sidelink feedback communication such that a waveform associated with the first format is repeated in each RB-set of the plurality of RB-sets. For example, the UE 120-1 may transmit the wideband sidelink feedback communication such that a 20 MHz PF2 PSFCH is repeated in each RB-set of the plurality of RB-sets. In some such aspects, a frequency division OCC (FD-OCC) sequence is randomized across the plurality of RB-sets. In some aspects, the transmission of the PSFCH communication in the COT may require a one-shot LBT in each of the RB-sets. In some aspects, repetition of the waveform increases HARQ robustness since the PSFCH is repeated in multiple RB-sets and the transmission in each RB-set is gated by an LBT outcome at each RB-set (e.g., a partial transmission can be performed by puncturing an RB-set that does not pass LBT).

In some aspects, the UE 120-1 transmits the sidelink feedback communication such that feedback information is carried in at least one RB-set of the plurality of RB-sets and a COT holding signal is carried in at least one other RB-set of the plurality of RB-sets. That is, in some aspects, feedback information (e.g., an ACK/NACK) need not be carried by all of the RB-sets (e.g., the feedback information may be carried in only a leading RB-set) and a COT holding signal may be transmitted in the remaining RB-sets. In some aspects, such operation enables a PSFCH resource in the remaining RB-sets to be used by other links, thereby improving network throughput and reducing latency associated with other communications.

In some aspects, the UE 120-1 transmits the wideband sidelink feedback communication is transmitted according to the first format in a first RB-set of the plurality of RB-sets and according to a second format in a set of reserved CS RBs or in a common interlace within a second RB-set of the plurality of RB-sets. For example, the UE 120-1 may transmit a 20 MHz PF2 PSFCH in a leading RB-set of the COT and may transmit a PF0 PSFCH in reserved CS resources in the remaining RB-sets. In some such aspects, the UE 120-1 may transmit the sidelink feedback communication such that feedback information is carried in the first RB-set and a COT holding signal is carried in one or more other RB-sets. In some such aspects, if the UE 120-1 is configured such that each PSFCH communication is to occupy a common interlace and zero or one or more dedicated physical RBs, then the UE 120-1 may transmit the COT holding signal with PF0 in a PF0 common interlace or a reserved CS resource. Alternatively, if the UE 120-1 is configured such that each PSFCH communication is to occupy one or more dedicated physical RBs and one or more common physical RBs, then the UE 120-1 may transmit the transmit COT holding signal with PF0 in a PF0 reserved CS and any interlace in a PF0 resource pool.

In some aspects, the RB-set configurations for PSFCH resources vary among RB-sets in the plurality of RB-sets. That is, PSFCH resources may be configured differently among the plurality of RB-sets (e.g., according to different RB-set specific configurations as described above with respect to FIGS. 9A and 9B). In some such aspects, the UE 120-1 transmits the wideband sidelink feedback communication according to the first format in one or more RB-sets of the plurality of RB-sets in which a PSFCH resource corresponding to an interlace of the second plurality of interlaces is configured for the first format. Here, the UE 120-1 may transmit the wideband sidelink feedback communication according to a second format in a set of reserved CS RBs or in a common interlace within at least one RB-set of the plurality of RB-sets in which a PSFCH resource corresponding the interlace is configured for a second format. For example, in some aspects, the UE 120-1 may repeat a 20 MHz PF2 PSFCH in the same interlace in the RB-sets where PF2 resources in the same interlace are available. Otherwise, the UE 120-1 may transmit a PF0 based COT holding signal in the reserved CS (e.g., in the same interlace) or the common interlace. In some aspects, some RB-sets may not include any PF2 resources or PF2 resources in the same interlace index as in a primary RB-set. In such a scenario, such resources are allocated for PF0. For those RB-sets, the UE 120-1 may in some aspects transmit a PF0-based COT holding signal (e.g., in reserved CS resources of the same interlace, or in a common interlace). Thus, in some aspects, the UE 120-1 may transmit a COT holding signal in the set of reserved CS RBs or in the common interlace in the at least one RB-set in which the PSFCH resource corresponding the interlace is configured for the second format.

In some aspects, the first format is PF0. That is, in some aspects, the wideband sidelink feedback communication may be a wideband PSFCH communication with PF0 (e.g., capacity enhanced PF0). In some such aspects, the UE 120-1 may transmit the wideband sidelink feedback communication such that a repetition of an RB carrying feedback information (e.g., an ACK/NACK) is carried in each RB-set of the plurality of RB-sets. Here, the UE 120-1 may transmit the wideband sidelink feedback communication such that a repetition of a common interlace is carried in at least one RB-set in the plurality of RB-sets (e.g., if the UE 120-1 is configured such that each PSFCH communication is to occupy a common interlace and zero or one or more dedicated physical RBs). Alternatively, the UE 120-1 may transmit the wideband sidelink feedback communication such that a repetition of a set of reserved CS RBs is carried in at least one RB-set of the plurality of RB-sets (e.g., if the UE 120-1 is configured such that each PSFCH communication is to occupy one or more dedicated physical RBs and one or more common physical RBs). In some aspects, CS ramping may be performed across different RB-sets for the reserved CS RBs, the common interlace, or the feedback information carrying interlace RBs to reduce a peak-to-average-power ratio (PAPR).

In some aspects, the UE 120-1 may transmit the wideband sidelink feedback communication such that a repetition of an RB carrying feedback information is carried in at least one RB-set of the plurality of RB-sets and such that a repetition of a common interlace is carried in other RB-sets of the plurality of RB-sets. Additionally, or alternatively, the UE 120-1 may transmit the wideband sidelink feedback communication such that a repetition of an RB carrying feedback information is carried in at least one RB-set of the plurality of RB-sets and such that a repetition of a set of reserved CS RBs is carried in other RB-sets of the plurality of RB-sets.

As indicated above, FIG. 10 is provided as an example. Other examples may differ from what is described with respect to FIG. 10.

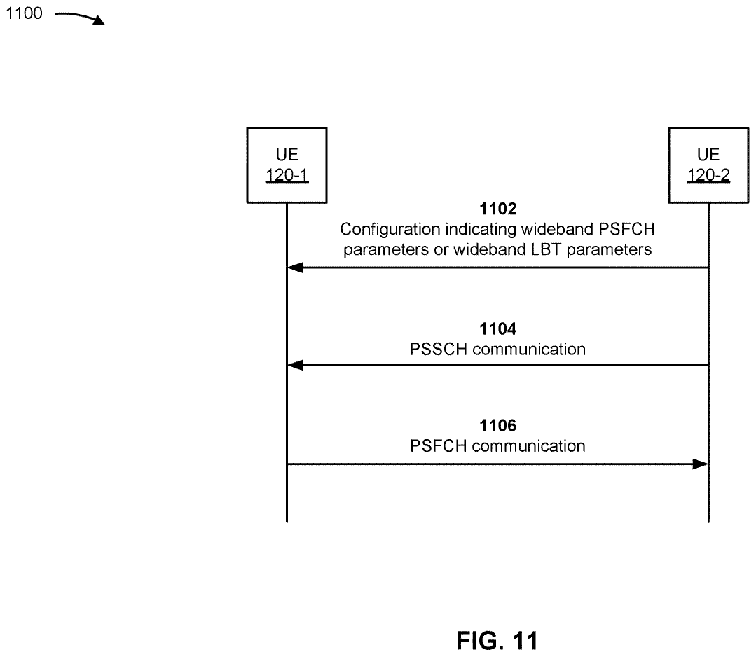

FIG. 11 is a diagram illustrating an example 1100 associated with an SL-U wideband PSFCH for capacity enhanced PF0 or PF2, in accordance with the present disclosure. As shown in FIG. 11, example 1100 includes communication between a UE 120-1 and a UE 120-2. In some aspects, a UE 120 (e.g., the UE 120-1 or the UE 120-2) may correspond to a UE 305, a UE 405, a UE 410, or another device as described herein. In some aspects, the UE 120-1 and the UE 120-2 may be included in a wireless network, such as wireless network 100. The UE 120-1 and the UE 120-2 may communicate via a wireless access link, such as a sidelink (e.g., in the unlicensed spectrum).

A channel access type associated with transmitting a wideband sidelink feedback communication (e.g., wideband PSFCH) may be no LBT, type 2A LBT, type 2B LBT, or type 1 LBT. Notably, wideband LBT may allow for all or nothing LBT (e.g., such that only full transmissions are allowed) or independent LBT (e.g., such that partial transmissions are allowed). Therefore, in some aspects, the UE 120-2 (i.e., the transmitter UE 120) may need to indicate to the UE 120-1 (i.e., the receiver UE) one or more wideband PSFCH parameters (e.g., including an indication of whether wideband PSFCH is needed) and/or a set of channel access parameters (e.g., a set of parameters associated with performing wideband LBT).

In one example, as shown by reference 1102, the UE 120-2 may transmit, to the UE 120-1, a configuration indicating a set of wideband PSFCH parameters or a set of wideband LBT parameters. In some aspects, the set of PSFCH parameters indicates one or more RB-sets in which the UE 120-1 is to transmit a wideband sidelink feedback communication associated with a sidelink communication. That is, the configuration may in some aspects identify one or more RB-sets in which the UE 120-1 is to transmit a wideband PSFCH. Additionally, or alternatively, the set of PSFCH parameters may indicate a cyclic prefix extension (CPE) parameter to be used by the UE 120-1 in association with transmitting the wideband sidelink feedback communication associated with the sidelink communication. Additionally, or alternatively, the set of LBT parameters may indicate a type of LBT to be performed by the UE 120-1 prior to transmitting the wideband sidelink feedback communication associated with the sidelink communication. That is, the configuration may, in some aspects, identify a type of LBT to be performed in association with a PSFCH transmission.

In some aspects, the UE 120-2 may transmit, and the UE 120-1 may receive, an indication that the UE 120-1 is to transmit a wideband sidelink feedback communication associated with the sidelink communication. For example, the UE 120-2 may determine that the UE 120-2 is to resume transmission of the sidelink communication after a PSFCH instance, and may transmit (e.g., with the configuration or separate from the configuration) an indication that the UE 120-1 is to transmit a wideband sidelink feedback communication associated with the sidelink communication. Thus, the UE 120-2 (i.e., the transmitter UE) may in some aspects determine that the UE 120-2 to continue a wideband transmission after the PSFCH instance, and may signal to the UE 120-1 (i.e., the receiver UE) that feedback information (e.g., an ACK/NACK) to be transmitted via a wideband PSFCH. In some aspects, the UE 120-2 may resume the transmission of the sidelink communication after the PSFCH instance (e.g., after transmitting the sidelink communication and receiving the wideband sidelink feedback communication as described below). Notably, from the perspective of the UE 120-2, as long as the wideband PSFCH is scheduled with proper gap control, the UE 120-2 may resume the wideband COT transmission regardless of whether the UE 120-1 actually transmits a wideband PSFCH.

Alternatively, the UE 120-2 may transmit, and the UE 120-1 may receive, an indication that the UE 120-1 is to transmit a narrowband sidelink feedback communication associated with the sidelink communication. For example, the UE 120-2 may determine that the UE 120-2 is not to resume transmission of the sidelink communication after a PSFCH instance, and may transmit (e.g., with the configuration or separate from the configuration) an indication that the UE 120-1 is to transmit a narrowband sidelink feedback communication associated with the sidelink communication. Thus, the UE 120-2 (i.e., the transmitter UE) may in some aspects determine that the UE 120-2 does not need to continue a wideband transmission after the PSFCH instance, and may signal to the UE 120-1 (i.e., the receiver UE) that feedback information (e.g., an ACK/NACK) to be transmitted via a narrowband PSFCH.

As shown by reference 1104, the UE 120-2 may transmit, and the UE 120-1 may receive, a sidelink communication to the first UE after transmitting the configuration. For example, the UE 120-2 may transmit, and the UE 120-1 may receive, a PSSCH communication in a PSSCH resource corresponding to one or more PSSCH interlaces of one or more RB-sets.

As shown by reference 1106, in some aspects, the UE 120-1 may transmit, and the UE 120-2 may receive a sidelink feedback communication after transmitting the sidelink communication. For example, the UE 120-1 may receive the configuration (e.g., including an indication that the UE 120-1 is to transmit a wideband sidelink feedback communication) and the sidelink communication as described above. Here, the UE 120-1 may transmit the wideband sidelink feedback communication (e.g., the wideband PSFCH) according to the configuration. For example, the UE 120-1 may perform LBT according to the configuration (e.g., all or nothing LBT or independent wideband LBT) and may transmit the wideband PSFCH accordingly (e.g., based at least in part on a set of wideband PSFCH parameters included in the configuration). As another example, the UE 120-1 may transmit a narrowband sidelink feedback communication (e.g., based at least in part on an indication received from the UE 120-2 as described above).

As indicated above, FIG. 11 is provided as an example. Other examples may differ from what is described with respect to FIG. 11.

FIG. 12 is a diagram illustrating an example process 1200 performed, for example, by a UE, in accordance with the present disclosure. Example process 1200 is an example where the UE (e.g., UE 120) performs operations associated with SL-U wideband PSFCH for capacity enhanced PF0 or PF2.

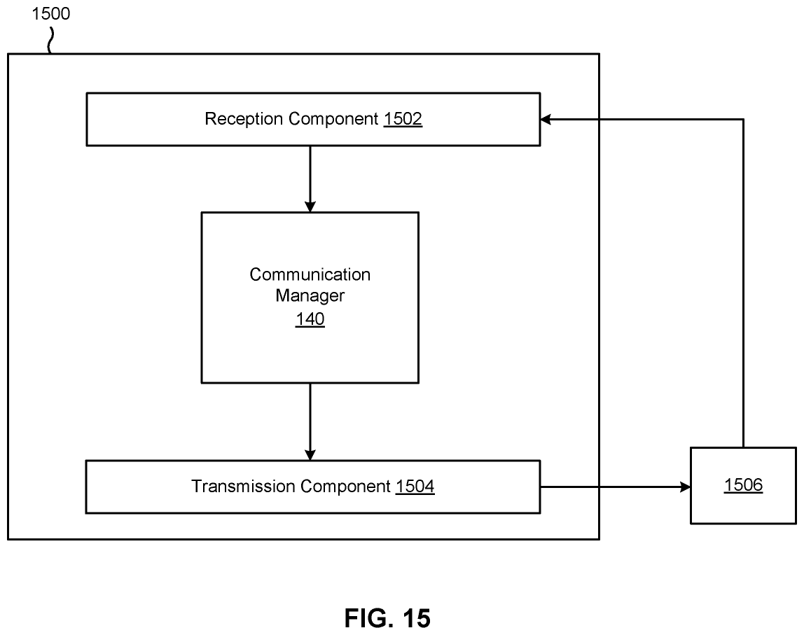

As shown in FIG. 12, in some aspects, process 1200 may include receiving a plurality of RB-set specific configurations, each RB-set specific configuration corresponding to a respective RB-set from a plurality of RB-sets in a shared frequency band, wherein each RB-set specific configuration of the plurality of RB-set specific configurations indicates at least one of a first set of PSFCH resources having a first format or a second set of PSFCH resources having a second format that is different from the first format (block 1210). For example, the UE (e.g., using communication manager 140 and/or reception component 1502, depicted in FIG. 15) may receive a plurality of RB-set specific configurations, each RB-set specific configuration corresponding to a respective RB-set from a plurality of RB-sets in a shared frequency band, wherein each RB-set specific configuration of the plurality of RB-set specific configurations indicates at least one of a first set of PSFCH resources having a first format or a second set of PSFCH resources having a second format that is different from the first format, as described above.

As further shown in FIG. 12, in some aspects, process 1200 may include receiving a sidelink communication in at least a first interlace of an RB-set included in the plurality of RB-sets (block 1220). For example, the UE (e.g., using communication manager 140 and/or reception component 1502, depicted in FIG. 15) may receive a sidelink communication in at least a first interlace of an RB-set included in the plurality of RB-sets, as described above.

As further shown in FIG. 12, in some aspects, process 1200 may include transmitting a sidelink feedback communication associated with the sidelink communication in at least a second interlace of the RB-set, wherein the sidelink feedback communication is transmitted based at least in part on an RB-set specific configuration associated with the RB-set (block 1230). For example, the UE (e.g., using communication manager 140 and/or transmission component 1504, depicted in FIG. 15) may transmit a sidelink feedback communication associated with the sidelink communication in at least a second interlace of the RB-set, wherein the sidelink feedback communication is transmitted based at least in part on an RB-set specific configuration associated with the RB-set, as described above. In some aspects, the sidelink feedback communication is transmitted based at least in part on an RB-set specific configuration associated with the RB-set.

Process 1200 may include additional aspects, such as any single aspect or any combination of aspects described below and/or in connection with one or more other processes described elsewhere herein.

In a first aspect, the plurality of RB-set specific configurations includes a first RB-set specific configuration and a second RB-set specific configuration that is different from the first RB-set specific configuration.

In a second aspect, alone or in combination with the first aspect, the plurality of RB-set specific configurations includes at least one RB-set specific configuration that indicates a set of PSFCH resources having a single format.

In a third aspect, alone or in combination with one or more of the first and second aspects, either the first format or the second format is PF0.

In a fourth aspect, alone or in combination with one or more of the first through third aspects, either the first format or the second format is PF2.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram illustrating an example process 1300 performed, for example, by a UE, in accordance with the present disclosure. Example process 1300 is an example where the UE (e.g., UE 120) performs operations associated with LS-U wideband PSFCH for capacity enhanced PF0 or PF2.

As shown in FIG. 13, in some aspects, process 1300 may include receiving a sidelink communication in a first plurality of interlaces of a plurality of RB-sets in a shared frequency band (block 1310). For example, the UE (e.g., using communication manager 140 and/or reception component 1502, depicted in FIG. 15) may receive a sidelink communication in a first plurality of interlaces of a plurality of RB-sets in a shared frequency band, as described above.

As further shown in FIG. 13, in some aspects, process 1300 may include transmitting a wideband sidelink feedback communication associated with the sidelink communication in a second plurality of interlaces of the plurality of RB-sets, the wideband sidelink feedback communication being transmitted in at least a first set of PSFCH resources having a first format (block 1320). For example, the UE (e.g., using communication manager 140 and/or transmission component 1504, depicted in FIG. 15) may transmit a wideband sidelink feedback communication associated with the sidelink communication in a second plurality of interlaces of the plurality of RB-sets, the wideband sidelink feedback communication being transmitted in at least a first set of PSFCH resources having a first format, as described above.

Process 1300 may include additional aspects, such as any single aspect or any combination of aspects described below and/or in connection with one or more other processes described elsewhere herein.

In a first aspect, the first format is PF2.

In a second aspect, alone or in combination with the first aspect, each RB-set of the plurality of RB-sets utilizes a same RB-set configuration for PSFCH resources.

In a third aspect, alone or in combination with one or more of the first and second aspects, the wideband sidelink feedback communication is transmitted such that a waveform associated with the first format spans the plurality of RB-sets.

In a fourth aspect, alone or in combination with one or more of the first through third aspects, the wideband sidelink feedback communication is transmitted such that a DMRS spans the plurality of RB-sets.

In a fifth aspect, alone or in combination with one or more of the first through fourth aspects, a payload of the wideband sidelink feedback communication is rate matched to the second plurality of interlaces or to RBs in the plurality of RB-sets.

In a sixth aspect, alone or in combination with one or more of the first through fifth aspects, the wideband sidelink feedback communication is transmitted such that a waveform associated with the first format is repeated in each RB-set of the plurality of RB-sets.

In a seventh aspect, alone or in combination with one or more of the first through sixth aspects, a frequency division orthogonal cover code (FD-OCC) sequence is randomized across the plurality of RB-sets.

In an eighth aspect, alone or in combination with one or more of the first through seventh aspects, the wideband sidelink feedback communication is transmitted such that feedback information is carried in at least one RB-set of the plurality of RB-sets and a COT holding signal is carried in at least one other RB-set of the plurality of RB-sets.

In a ninth aspect, alone or in combination with one or more of the first through eighth aspects, the wideband sidelink feedback communication is transmitted according to the first format in a first RB-set of the plurality of RB-sets and according to a second format in a set of reserved CS RBs or in a common interlace within a second RB-set of the plurality of RB-sets.

In a tenth aspect, alone or in combination with one or more of the first through ninth aspects, the wideband sidelink feedback communication is transmitted such that feedback information is carried in the first RB-set and a COT holding signal is carried in the second RB-set.

In an eleventh aspect, alone or in combination with one or more of the first through tenth aspects, RB-set configurations for PSFCH resources vary among RB-sets in the plurality of RB-sets.

In a twelfth aspect, alone or in combination with one or more of the first through eleventh aspects, the wideband sidelink feedback communication is transmitted according to the first format in one or more RB-sets of the plurality of RB-sets in which a PSFCH resource corresponding to an interlace of the second plurality of interlaces is configured for the first format.

In a thirteenth aspect, alone or in combination with one or more of the first through twelfth aspects, the wideband sidelink feedback communication is transmitted according to a second format in a set of reserved CS RBs or in a common interlace within at least one RB-set of the plurality of RB-sets in which a PSFCH resource corresponding the interlace is configured for a second format.

In a fourteenth aspect, alone or in combination with one or more of the first through thirteenth aspects, a COT holding signal is carried in the set of reserved CS RBs or in the common interlace in the at least one RB-set in which the PSFCH resource corresponding the interlace is configured for the second format.

In a fifteenth aspect, alone or in combination with one or more of the first through fourteenth aspects, the first format is PF0.

In a sixteenth aspect, alone or in combination with one or more of the first through fifteenth aspects, the wideband sidelink feedback communication is transmitted such that a repetition of an RB carrying feedback information is carried in each RB-set of the plurality of RB-sets.

In a seventeenth aspect, alone or in combination with one or more of the first through sixteenth aspects, the wideband sidelink feedback communication is transmitted such that a repetition of a common interlace is carried in at least one RB-set in the plurality of RB-sets.

In an eighteenth aspect, alone or in combination with one or more of the first through seventeenth aspects, the wideband sidelink feedback communication is transmitted such that a repetition of a set of reserved CS RBs is carried in at least one RB-set of the plurality of RB-sets.

In a nineteenth aspect, alone or in combination with one or more of the first through eighteenth aspects, the wideband sidelink feedback communication is transmitted such that a repetition of an RB carrying feedback information is carried in at least one RB-set of the plurality of RB-sets and such that a repetition of a common interlace is carried in other RB-sets of the plurality of RB-sets.

In a twentieth aspect, alone or in combination with one or more of the first through nineteenth aspects, the wideband sidelink feedback communication is transmitted such that a repetition of an RB carrying feedback information is carried in at least one RB-set of the plurality of RB-sets and such that a repetition of a set of reserved CS RBs is carried in other RB-sets of the plurality of RB-sets.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram illustrating an example process 1400 performed, for example, by a UE, in accordance with the present disclosure. Example process 1400 is an example where the UE (e.g., UE 120) performs operations associated with LS-U wideband PSFCH for capacity enhanced PF0 or PF2.

As shown in FIG. 14, in some aspects, process 1400 may include transmitting, to a second UE, a configuration indicating a set of wideband PSFCH parameters or a set of wideband LBT parameters (block 1410). For example, the UE (e.g., using communication manager 140 and/or transmission component 1504, depicted in FIG. 15) may transmit, to a second UE, a configuration indicating a set of wideband PSFCH parameters or a set of wideband LBT parameters, as described above.

As further shown in FIG. 14, in some aspects, process 1400 may include transmitting a sidelink communication to the second UE after transmitting the configuration (block 1420). For example, the UE (e.g., using communication manager 140 and/or transmission component 1504, depicted in FIG. 15) may transmit a sidelink communication to the second UE after transmitting the configuration, as described above.

Process 1400 may include additional aspects, such as any single aspect or any combination of aspects described below and/or in connection with one or more other processes described elsewhere herein.

In a first aspect, process 1400 includes receiving, from the second UE, a wideband sidelink feedback communication after transmitting the sidelink communication.

In a second aspect, alone or in combination with the first aspect, process 1400 includes transmitting an indication that the second UE is to transmit a wideband sidelink feedback communication associated with the sidelink communication based at least in part on a determination that the UE is to resume transmission of the sidelink communication after a PSFCH instance.

In a third aspect, alone or in combination with one or more of the first and second aspects, process 1400 includes resuming the transmission of the sidelink communication after the PSFCH instance.

In a fourth aspect, alone or in combination with one or more of the first through third aspects, process 1400 includes transmitting an indication that the second UE is to transmit a narrowband sidelink feedback communication associated with the sidelink communication based at least in part on a determination that the UE is to not to resume transmission of the sidelink communication after a PSFCH instance.

In a fifth aspect, alone or in combination with one or more of the first through fourth aspects, the set of PSFCH parameters indicates one or more RB-sets in which the second UE is to transmit a wideband sidelink feedback communication associated with the sidelink communication.

In a sixth aspect, alone or in combination with one or more of the first through fifth aspects, the set of LBT parameters indicates a type of LBT to be performed by the second UE prior to transmitting a wideband sidelink feedback communication associated with the sidelink communication.

In a seventh aspect, alone or in combination with one or more of the first through sixth aspects, the set of PSFCH parameters indicates a CPE parameter to be used by the second UE in association with transmitting a wideband sidelink feedback communication associated with the sidelink communication.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

FIG. 15 is a diagram of an example apparatus 1500 for wireless communication, in accordance with the present disclosure. The apparatus 1500 may be a UE, or a UE may include the apparatus 1500. In some aspects, the apparatus 1500 includes a reception component 1502 and a transmission component 1504, which may be in communication with one another (for example, via one or more buses and/or one or more other components). As shown, the apparatus 1500 may communicate with another apparatus 1506 (such as a UE, a base station, or another wireless communication device) using the reception component 1502 and the transmission component 1504. As further shown, the apparatus 1500 may include the communication manager 140.

In some aspects, the apparatus 1500 may be configured to perform one or more operations described herein in connection with FIGS. 9A-11. Additionally, or alternatively, the apparatus 1500 may be configured to perform one or more processes described herein, such as process 1200 of FIG. 12, process 1300 of FIG. 13, process 1400 of FIG. 14, or a combination thereof. In some aspects, the apparatus 1500 and/or one or more components shown in FIG. 15 may include one or more components of the UE described in connection with FIG. 2.

Additionally, or alternatively, one or more components shown in FIG. 15 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1502 may receive communications, such as reference signals, control information, data communications, or a combination thereof, from the apparatus 1506. The reception component 1502 may provide received communications to one or more other components of the apparatus 1500. In some aspects, the reception component 1502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1500. In some aspects, the reception component 1502 may include one or more antennas, a modem, a demodulator, a MIMO detector, a receive processor, a controller/processor, a memory, or a combination thereof, of the UE described in connection with FIG. 2.

The transmission component 1504 may transmit communications, such as reference signals, control information, data communications, or a combination thereof, to the apparatus 1506. In some aspects, one or more other components of the apparatus 1500 may generate communications and may provide the generated communications to the transmission component 1504 for transmission to the apparatus 1506. In some aspects, the transmission component 1504 may perform signal processing on the generated communications (such as filtering, amplification, modulation, digital-to-analog conversion, multiplexing, interleaving, mapping, or encoding, among other examples), and may transmit the processed signals to the apparatus 1506. In some aspects, the transmission component 1504 may include one or more antennas, a modem, a modulator, a transmit MIMO processor, a transmit processor, a controller/processor, a memory, or a combination thereof, of the UE described in connection with FIG. 2. In some aspects, the transmission component 1504 may be co-located with the reception component 1502 in a transceiver.

In some aspects, the reception component 1502 may receive a plurality of RB-set specific configurations, each RB-set specific configuration corresponding to a respective RB-set from a plurality of RB-sets in a shared frequency band wherein each RB-set specific configuration of the plurality of RB-set specific configurations indicates at least one of a first set of PSFCH resources having a first format or a second set of PSFCH resources having a second format that is different from the first format. In some aspects, the reception component 1502 may receive a sidelink communication in at least a first interlace of an RB-set included in the plurality of RB-sets. In some aspects, the transmission component 1504 may transmit a sidelink feedback communication associated with the sidelink communication in at least a second interlace of the RB-set wherein the sidelink feedback communication is transmitted based at least in part on an RB-set specific configuration associated with the RB-set.

In some aspects, the reception component 1502 may receive a sidelink communication in a first plurality of interlaces of a plurality of RB-sets in a shared frequency band. In some aspects, the transmission component 1504 may transmit a wideband sidelink feedback communication associated with the sidelink communication in a second plurality of interlaces of the plurality of RB-sets the wideband sidelink feedback communication being transmitted in at least a first set of PSFCH resources having a first format.

In some aspects, the transmission component 1504 may transmit, to a second UE, a configuration indicating a set of wideband PSFCH parameters or a set of wideband LBT parameters. The transmission component 1504 may transmit a sidelink communication to the second UE after transmitting the configuration. In some aspects, the reception component 1502 may receive, from the second UE, a wideband sidelink feedback communication after transmitting the sidelink communication. In some aspects, the transmission component 1504 may transmit an indication that the second UE is to transmit a wideband sidelink feedback communication associated with the sidelink communication based at least in part on a determination that the first UE is to resume transmission of the sidelink communication after a PSFCH instance. In some aspects, the transmission component 1504 may resume the transmission of the sidelink communication after the PSFCH instance. In some aspects, the transmission component 1504 may transmit an indication that the second UE is to transmit a narrowband sidelink feedback communication associated with the sidelink communication based at least in part on a determination that the first UE is to not to resume transmission of the sidelink communication after a PSFCH instance.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

The following provides an overview of some Aspects of the present disclosure:
Aspect 1: A method of wireless communication performed by a UE, comprising: receiving a plurality of RB-set specific configurations, each RB-set specific configuration corresponding to a respective RB-set from a plurality of RB-sets in a shared frequency band, wherein each RB-set specific configuration of the plurality of RB-set specific configurations indicates at least one of a first set of PSFCH resources having a first format or a second set of PSFCH resources having a second format that is different from the first format; receiving a sidelink communication in at least a first interlace of an RB-set included in the plurality of RB-sets; and transmitting a sidelink feedback communication associated with the sidelink communication in at least a second interlace of the RB-set, wherein the sidelink feedback communication is transmitted based at least in part on an RB-set specific configuration associated with the RB-set.
Aspect 2: The method of Aspect 1, wherein the plurality of RB-set specific configurations includes a first RB-set specific configuration and a second RB-set specific configuration that is different from the first RB-set specific configuration.
Aspect 3: The method of any of Aspects 1-2, wherein the plurality of RB-set specific configurations includes at least one RB-set specific configuration that indicates a set of PSFCH resources having a single format.
Aspect 4: The method of any of Aspects 1-3, wherein either the first format or the second format is PF0.
Aspect 5: The method of any of Aspects 1-4, wherein either the first format or the second format is PF2.
Aspect 6: A method of wireless communication performed by a UE, comprising: receiving a sidelink communication in a first plurality of interlaces of a plurality of RB-sets in a shared frequency band; and transmitting a wideband sidelink feedback communication associated with the sidelink communication in a second plurality of interlaces of the plurality of RB-sets, the wideband sidelink feedback communication being transmitted in at least a first set of PSFCH resources having a first format.
Aspect 7: The method of Aspect 6, wherein the first format is PF2.
Aspect 8: The method of any of Aspects 6-7, wherein each RB-set of the plurality of RB-sets utilizes a same RB-set configuration for PSFCH resources.
Aspect 9: The method of any of Aspects 6-8, wherein the wideband sidelink feedback communication is transmitted such that a waveform associated with the first format spans the plurality of RB-sets.
Aspect 10: The method of Aspect 9, wherein the wideband sidelink feedback communication is transmitted such that a DMRS spans the plurality of RB-sets.
Aspect 11: The method of Aspect 9, wherein a payload of the wideband sidelink feedback communication is rate matched to the second plurality of interlaces or to RBs in the plurality of RB-sets.
Aspect 12: The method of any of Aspects 6-11, wherein the wideband sidelink feedback communication is transmitted such that a waveform associated with the first format is repeated in each RB-set of the plurality of RB-sets.
Aspect 13: The method of Aspect 12, wherein a frequency division orthogonal cover code (FD-OCC) sequence is randomized across the plurality of RB-sets.
Aspect 14: The method of any of Aspects 6-13, wherein the wideband sidelink feedback communication is transmitted such that feedback information is carried in at least one RB-set of the plurality of RB-sets and a COT holding signal is carried in at least one other RB-set of the plurality of RB-sets.
Aspect 15: The method of any of Aspects 6-14, wherein the wideband sidelink feedback communication is transmitted according to the first format in a first RB-set of the plurality of RB-sets and according to a second format in a set of reserved CS RBs or in a common interlace within a second RB-set of the plurality of RB-sets.
Aspect 16: The method of Aspect 15, wherein the wideband sidelink feedback communication is transmitted such that feedback information is carried in the first RB-set and a COT holding signal is carried in the second RB-set.
Aspect 17: The method of any of Aspects 6-16, wherein RB-set configurations for PSFCH resources vary among RB-sets in the plurality of RB-sets.
Aspect 18: The method of any of Aspects 6-17, wherein the wideband sidelink feedback communication is transmitted according to the first format in one or more RB-sets of the plurality of RB-sets in which a PSFCH resource corresponding to an interlace of the second plurality of interlaces is configured for the first format.
Aspect 19: The method of Aspect 18, wherein the wideband sidelink feedback communication is transmitted according to a second format in a set of reserved CS RBs or in a common interlace within at least one RB-set of the plurality of RB-sets in which a PSFCH resource corresponding the interlace is configured for a second format.
Aspect 20: The method of Aspect 19, wherein a COT holding signal is carried in the set of reserved CS RBs or in the common interlace in the at least one RB-set in which the PSFCH resource corresponding the interlace is configured for the second format.
Aspect 21: The method of any of Aspects 6-20, wherein the first format is PF0,
Aspect 22: The method of any of Aspects 6-21, wherein the wideband sidelink feedback communication is transmitted such that a repetition of an RB carrying feedback information is carried in each RB-set of the plurality of RB-sets.
Aspect 23: The method of Aspect 22, wherein the wideband sidelink feedback communication is transmitted such that a repetition of a common interlace is carried in at least one RB-set in the plurality of RB-sets.
Aspect 24: The method of Aspect 22, wherein the wideband sidelink feedback communication is transmitted such that a repetition of a set of reserved CS RBs is carried in at least one RB-set of the plurality of RB-sets.
Aspect 25: The method of Aspect 22, wherein the wideband sidelink feedback communication is transmitted such that a repetition of an RB carrying feedback information is carried in at least one RB-set of the plurality of RB-sets and such that a repetition of a common interlace is carried in other RB-sets of the plurality of RB-sets.
Aspect 26: The method of Aspect 22, wherein the wideband sidelink feedback communication is transmitted such that a repetition of an RB carrying feedback information is carried in at least one RB-set of the plurality of RB-sets and such that a repetition of a set of reserved CS RBs is carried in other RB-sets of the plurality of RB-sets.
Aspect 27: A method of wireless communication performed by a first UE, comprising: transmitting, to a second UE, a configuration indicating a set of wideband PSFCH parameters or a set of wideband LBT parameters; and transmitting a sidelink communication to the second UE after transmitting the configuration.
Aspect 28: The method of Aspect 27, further comprising receiving, from the second UE, a wideband sidelink feedback communication after transmitting the sidelink communication.
Aspect 29: The method of any of Aspects 27-28, further comprising transmitting an indication that the second UE is to transmit a wideband sidelink feedback communication associated with the sidelink communication based at least in part on a determination that the first UE is to resume transmission of the sidelink communication after a PSFCH instance.
Aspect 30: The method of Aspect 29, further comprising resuming the transmission of the sidelink communication after the PSFCH instance.
Aspect 31: The method of any of Aspects 27-30, further comprising transmitting an indication that the second UE is to transmit a narrowband sidelink feedback communication associated with the sidelink communication based at least in part on a determination that the first UE is to not to resume transmission of the sidelink communication after a PSFCH instance.
Aspect 32: The method of any of Aspects 27-31, wherein the set of PSFCH parameters indicates one or more RB-sets in which the second UE is to transmit a wideband sidelink feedback communication associated with the sidelink communication.
Aspect 33: The method of any of Aspects 27-32, wherein the set of LBT parameters indicates a type of LBT to be performed by the second UE prior to transmitting a wideband sidelink feedback communication associated with the sidelink communication.
Aspect 34: The method of any of Aspects 27-33, wherein the set of PSFCH parameters indicates a cyclic prefix extension (CPE) parameter to be used by the second UE in association with transmitting a wideband sidelink feedback communication associated with the sidelink communication.
Aspect 35: An apparatus for wireless communication at a device, comprising a processor; memory coupled with the processor; and instructions stored in the memory and executable by the processor to cause the apparatus to perform the method of one or more of Aspects 1-34.
Aspect 36: A device for wireless communication, comprising a memory and one or more processors coupled to the memory, the one or more processors configured to perform the method of one or more of Aspects 1-34.
Aspect 37: An apparatus for wireless communication, comprising at least one means for performing the method of one or more of Aspects 1-34.
Aspect 38: A non-transitory computer-readable medium storing code for wireless communication, the code comprising instructions executable by a processor to perform the method of one or more of Aspects 1-34.
Aspect 39: A non-transitory computer-readable medium storing a set of instructions for wireless communication, the set of instructions comprising one or more instructions that, when executed by one or more processors of a device, cause the device to perform the method of one or more of Aspects 1-34.

The foregoing disclosure provides illustration and description but is not intended to be exhaustive or to limit the aspects to the precise forms disclosed. Modifications and variations may be made in light of the above disclosure or may be acquired from practice of the aspects.

Further disclosure is included in the appendix. The appendix is provided as an example only and is to be considered part of the specification. A definition, illustration, or other description in the appendix does not supersede or override similar information included in the detailed description or figures. Furthermore, a definition, illustration, or other description in the detailed description or figures does not supersede or override similar information included in the appendix. Furthermore, the appendix is not intended to limit the disclosure of possible aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. An apparatus for wireless communications at a user equipment (UE), comprising: a processor;
memory coupled with the processor; and
instructions stored in the memory and executable by the processor to cause the apparatus to:
receive a plurality of resource block (RB)-set specific configurations, each RB-set specific configuration corresponding to a respective RB-set from a plurality of RB-sets in a shared frequency band,
wherein each RB-set specific configuration of the plurality of RB-set specific configurations indicates at least one of a first set of physical sidelink feedback channel (PSFCH) resources having a first format or a second set of PSFCH resources having a second format that is different from the first format;
receive a sidelink communication in at least a first interlace of an RB-set included in the plurality of RB-sets; and
transmit a sidelink feedback communication associated with the sidelink communication in at least a second interlace of the RB-set,
wherein the sidelink feedback communication is transmitted based at least in part on an RB-set specific configuration associated with the RB-set.

2. The apparatus of claim 1, wherein the plurality of RB-set specific configurations includes a first RB-set specific configuration and a second RB-set specific configuration that is different from the first RB-set specific configuration.

3. The apparatus of claim 1, wherein the plurality of RB-set specific configurations includes at least one RB-set specific configuration that indicates a set of PSFCH resources having a single format.

4. The apparatus of claim 1, wherein the first format is PSFCH format 0 (PF0) and the second format is PSFCH format 2 (PF0).

5. An apparatus for wireless communications at a user equipment (UE), comprising:
a processor;
memory coupled with the processor; and
instructions stored in the memory and executable by the processor to cause the apparatus to:
receive a sidelink communication in a first plurality of interlaces of a plurality of resource block (RB)-sets in a shared frequency band; and
transmit a wideband sidelink feedback communication associated with the sidelink communication in a second plurality of interlaces of the plurality of RB-sets,
the wideband sidelink feedback communication being transmitted in at least a first set of physical sidelink feedback channel (PSFCH) resources having a first format.

6. The apparatus of claim 5, wherein the first format is PSFCH format 2 (PF2).

7. The apparatus of claim 5, wherein each RB-set of the plurality of RB-sets utilizes a same RB-set configuration for PSFCH resources.

8. The apparatus of claim 5, wherein the wideband sidelink feedback communication is transmitted such that a waveform associated with the first format spans the plurality of RB-sets.

9. The apparatus of claim 8, wherein the wideband sidelink feedback communication is transmitted such that a demodulation reference signal (DMRS) spans the plurality of RB-sets.

10. The apparatus of claim 8, wherein a payload of the wideband sidelink feedback communication is rate matched to the second plurality of interlaces or to RBs in the plurality of RB-sets.

11. The apparatus of claim 5, wherein the wideband sidelink feedback communication is transmitted such that a waveform associated with the first format is repeated in each RB-set of the plurality of RB-sets.

12. The apparatus of claim 11, wherein a frequency division orthogonal cover code (FD-OCC) sequence is randomized across the plurality of RB-sets.

13. The apparatus of claim 5, wherein the wideband sidelink feedback communication is transmitted such that feedback information is carried in at least one RB-set of the plurality of RB-sets and a channel occupancy time (COT) holding signal is carried in at least one other RB-set of the plurality of RB-sets.

14. The apparatus of claim 5, wherein the wideband sidelink feedback communication is transmitted according to the first format in a first RB-set of the plurality of RB-sets and according to a second format in a set of reserved cyclic shift (CS) RBs or in a common interlace within a second RB-set of the plurality of RB-sets.

15. The apparatus of claim 14, wherein the wideband sidelink feedback communication is transmitted such that feedback information is carried in the first RB-set and a channel occupancy time (COT) holding signal is carried in the second RB-set.

16. The apparatus of claim 5, wherein RB-set configurations for PSFCH resources vary among RB-sets in the plurality of RB-sets.

17. The apparatus of claim 5, wherein the wideband sidelink feedback communication is transmitted according to the first format in one or more RB-sets of the plurality of RB-sets in which a PSFCH resource corresponding to an interlace of the second plurality of interlaces is configured for the first format.

18. The apparatus of claim 17, wherein the wideband sidelink feedback communication is transmitted according to a second format in a set of reserved cyclic shift (CS) RBs or in a common interlace within at least one RB-set of the plurality of RB-sets in which a PSFCH resource corresponding the interlace is configured for a second format.

19. The apparatus of claim 18, wherein a channel occupancy time (COT) holding signal is carried in the set of reserved CS RBs or in the common interlace in the at least one RB-set in which the PSFCH resource corresponding the interlace is configured for the second format.

20-23. (canceled)

24. An apparatus for wireless communications at a first user equipment (UE), comprising:
a processor;
memory coupled with the processor; and
instructions stored in the memory and executable by the processor to cause the apparatus to:
transmit, to a second UE, a configuration indicating a set of wideband physical sidelink feedback channel (PSFCH) parameters or a set of wideband listen-before-talk (LBT) parameters; and
transmit a sidelink communication to the second UE after transmitting the configuration.

25-31. (canceled)
